(19) United States
(12) Patent Application Publication
(10) Pub. No.: US 2010/0239479 A1
(43) Pub. Date: Sep. 23, 2010

(54) Process For Removing Toxic Metals From A Fluid Stream

(75) Inventors: Kishor Purushottam Gadkaree, Painted Post, NY (US); Benedict Yorke Johnson, Horseheads, NY (US); Pei Qiong Kuang, Horseheads, NY (US); Anbo Liu, Painted Post, NY (US)

Correspondence Address: CORNING INCORPORATED, SP-TI-3-1, CORNING, NY, 14831, US

(73) Assignee: Corning Incorporated, Corning, NY (US)

(21) Appl. No.: 12/675,309

(22) PCT Filed: Aug. 27, 2008
(86) PCT No.: PCT/US08/10155

§ 371 Date: Feb. 25, 2010

Related U.S. Application Data
(60) Provisional application No. 60/966,657, filed on Aug. 29, 2007.

(51) Int. Cl. B01D 53/64

(52) U.S. Cl. 423/215.5; 423/210; 502/417

(57) ABSTRACT

A process for removing at least one of As, Cd, Hg and Se from a fluid stream, comprising: (I) providing a plurality of Group A particles of a Group A sorbent material, said Group A sorbent material comprising: an activated carbon matrix defining a plurality of pores; sulfur; and an additive adapted for promoting the removal of at least one of As, Cd, Hg and Se from a fluid stream, wherein the additive is distributed throughout the activated carbon matrix; and (II) contacting the fluid stream with a plurality of Group A particles of the Group A sorbent material. The process can involve powder injection, a packed sorbent bed, a fluidized sorbent bed, and combinations thereof.

### CROSS-REFERENCED TO RELATED APPLICATION

This application claims the benefit of priority to U.S. provisional application No. 60/966,657, filed on Aug. 29, 2007, which is incorporated by reference herein.

### TECHNICAL FIELD

The present invention relates to processes for removing toxic metals from a fluid stream and processes for making sorbent particles for such processes for removing toxic elements. In particular, the present invention relates to a toxic-element-abating process comprising contacting a fluid stream comprising the toxic element with particles of a sorbent material comprising activated carbon and sulfur, and capable of removing toxic elements from a fluid stream such as a gas stream, and a process for making particles of such sorbent material by an air dry process. The present invention is useful, for example, in removing mercury from the flue gas stream resulting from carbon combustion.

### BACKGROUND

Mercury is both a global pollutant and a contaminant that can be transformed to a potentially toxic species (e.g., methylmercury) under natural conditions. Mercury emitted to the atmosphere can travel thousands of miles before being deposited to the earth. Studies show that mercury from the atmosphere can also be deposited in areas near the emission source. Mercury intake by human beings, especially children, can cause a variety of health problems.

Coal-fired power plants and medical and municipal waste incineration are major sources of human activity relating to mercury emission to the atmosphere. It is estimated that there are 48 tons of mercury emitted from coal-fired power plants in US annually. However, so far there is no effective mercury emission control technology available at a reasonable cost, especially for elemental mercury emission control.

The state of the art technology that has shown promise for controlling elemental mercury as well as oxidized mercury is active carbon injection (ACI). The ACI process includes injecting active carbon powder into the flue gas stream and using fabric filter (FF) or electrostatic precipitator (ESP) to collect the active carbon powder that has adsorbed mercury. Generally, ACI technologies, limited by the performance of activated carbon powder material, require a high carbon to Hg ratio to achieve the desired mercury removal level (>90%), which results in a high cost for sorbent material. The high carbon to Hg ratio suggests that ACI technology using conventional activated carbon materials does not utilize the mercury sorption capacity of carbon powder efficiently.

Since water-soluble (oxidized) mercury is the main mercury species in bituminous coal flue gas with high concentrations of SO₂ and HCl, bituminous coal-fired plants may be able to remove 90% mercury using a wet scrubber combined with NOx and/or SO₂ control technologies. Mercury emission control can also achieve as a co-benefit of particulate emission control. Chelating agent may be added to a wet scrubber to sequestrate the mercury from emitting again. However, a chelating agent adds to the cost due to the problems of corrosion of the metal scrubber equipment and treatment of chelating solution. However, elemental mercury is the dominant mercury species in the flue gas of sub-bituminous coal or lignite coal and a wet scrubber is not effective for removal of elemental mercury unless additional chemicals are added to the system. The prior art discloses adding various chemicals to the gas stream to aid the removal of mercury. However, it is undesirable to add additional potentially environmentally hazardous material into the flue gas system.

Certain industrial gases, such as the syngas produced in coal gasification, may contain toxic elements such as arsenic, cadmium and selenium, in addition to mercury. It is highly desired that all these toxic elements be substantially abated before the syngas is supplied for industrial and/or residential use.

There is a genuine need of a sorbent material and/or process capable of removing mercury and/or other toxic elements from fluid streams such as flue gas and syngas with a high capacity.

### SUMMARY

Accordingly, provided in the present invention is a process for removing at least one of As, Cd, Hg and Se from a fluid stream, comprising:

(I) providing a plurality of Group A particles of a Group A sorbent material, said Group A sorbent material comprising:

an activated carbon matrix defining a plurality of pores;

sulfur; and

an additive adapted for promoting the removal of at least one of As, Cd, Hg and Se from a fluid stream,

wherein:

the additive is distributed throughout the activated carbon matrix; and

(II) contacting the fluid stream with a plurality of the Group A particles.

According to certain embodiments of the process of the present invention, step (I) comprises:

(I.1) providing a precursor sorbent body having a nominal volume of at least 1 mm³, consisting essentially of the Group A sorbent material; and

(I.2) pulverizing the precursor sorbent body to form a plurality of Group A particles.

According to certain embodiments of the process of the present invention, in step (I.1), in the precursor sorbent body, sulfur is distributed throughout the activated carbon matrix.

According to certain embodiments of the process of the present invention, in step (I.1), in the precursor sorbent body, the additive is essentially homogeneously distributed in the activated carbon matrix.

According to certain embodiments of the process of the present invention, in step (I.1), in the precursor sorbent body, sulfur is essentially homogeneously distributed in the activated carbon matrix.

According to certain embodiments of the process of the present invention, step (I.1) comprises the following steps:

(A) providing a batch mixture body formed of a batch mixture material comprising a carbon-source material, a sulfur-source material, an additive-source material and an optional filler material, wherein the additive-source material is substantially homogeneously distributed in the mixture;

(B) carbonizing the batch mixture body by subjecting the batch mixture body to an elevated carbonizing temperature in an O₂-depleted atmosphere; and

(C) activating the carbonized batch mixture body at an elevated activating temperature in a CO₂ and/or H₂O-containing atmosphere.

According to certain embodiments of the process of the present invention, step (I) comprises the following steps:

(a) providing a plurality of batch-mixture particles comprising a carbon-source material, a sulfur-source material, an additive-source material and an optional filler material, wherein the additive-source material is substantially homogeneously distributed in the particles;

(b) carbonizing the batch mixture particles by subjecting the batch mixture particle to an elevated carbonizing temperature in an O₂-depleted atmosphere to obtain a carbonized batch mixture body; and

(c) activating the carbonized batch mixture particles at an elevated activating temperature in a CO₂ and/or H₂O-containing atmosphere.

According to certain specific embodiments of the embodiment of the present I invention described immediately above, step (a) comprises:

(a1) mixing a carbon-source material, a sulfur-source material, an additive-source material and an optional filler material to obtain an essentially uniform mixture;

(a2) forming wet particles from the mixture; and (a3) drying the wet particles to obtain dry batch-mixture particles.

According to certain embodiments of the process of the present invention (hereinafter “powder embodiments”):

in step (II), at least part of the plurality of Group A particles are introduced into the fluid stream at a Group A particle introduction location in the form of sorbent powder;

the Group A particles of the sorbent powder are allowed to travel with the fluid stream to a downstream Group A particle collecting location; and

the process further comprises a step (II) as follows:

(III) collecting at least part of the Group A particles of the sorbent powder at the Group A particle collecting location.

According to certain specific embodiments of the powder embodiments of the present invention comprising a step (III) above, the plurality of Group A particles of the sorbent powder have essentially the same composition.

According to certain embodiments of the process of the present invention comprising a step (III) above, step (III) comprises: collecting a majority of the Group A particles of the sorbent powder by using a fabric filter powder collector, an electrostatic precipitator, and combinations thereof.

According to certain embodiments of the process of the present invention comprising a step (III) above, the Group A particles of the sorbent powder have an average particle size ranging from 1 to 200 μm. In certain embodiments from 5 to 100 μm; in certain other embodiments from 5 to 30 μm.

According to certain embodiments of the process of the present invention (hereinafter “sorbent bed embodiments”), in step (II), at least part of the plurality of Group A particles form a sorbent bed. In certain specific embodiments, the sorbent bed is a packed sorbent bed. In certain other specific embodiments, the sorbent bed is a fluidized sorbent bed. In certain other specific embodiments, the sorbent bed is a combination of a packed sorbent bed and a fluidized sorbent bed.

According to certain specific embodiments of the sorbent bed embodiments of the process of the present invention, the plurality of Group A particles contained in the sorbent bed have essentially the same composition.

According to certain embodiments of the process of the present invention, wherein in step (II) at least part of the plurality of Group A particles are contained in a packed sorbent bed, the Group A particles contained in the packed sorbent bed have an average particle size ranging from 5 to 1000 μm; in certain embodiments from 10 to 200 μm; in certain other embodiments from 10 to 100 μm.

According to certain embodiments of the process of the present invention, wherein in step (II) at least part of the plurality of Group A particles are contained in a fluidized sorbent bed, the Group A particles contained in the fluidized sorbent bed have an average particle size ranging from 1 to 200 μm; in certain embodiments from 1 to 100 μm; in certain other embodiments from 1 to 50 μm; in certain other embodiments from 1 to 20 μm.

According to certain embodiments of the process of the present invention (hereinafter “sorbent bed-powder combination embodiments”):

in step (II), part of the plurality of Group A particles are contained in a sorbent bed;

in step (II), part of the plurality of Group A particles are introduced into the fluid stream at a Group A particle introduction location in the form of sorbent powder;

the Group A particles of the sorbent powder are allowed to travel with the fluid stream to a downstream Group A particle collecting location; and the process further comprises a step (II) as follows:

(II) collecting at least part of the Group A particles of the sorbent powder at the Group A particle collecting location.

According to certain specific embodiments of the sorbent bed-powder combination embodiments of the process of the present invention, the sorbent bed is a fluidized sorbent bed. In other specific embodiments, the sorbent bed is a packed sorbent bed.

According to certain specific embodiments of sorbent bed-powder combination embodiments of the process of the present invention, the Group A particle collecting location of the sorbent powder is upstream relative to the sorbent bed and the Group A particle collecting location of the sorbent powder is downstream relative to the sorbent bed.

According to certain specific embodiments of sorbent bed-powder combination embodiments of the process of the present invention, the Group A particles of the sorbent powder have essentially the same composition, and the Group A particles contained in the sorbent bed have essentially the same composition.

According to certain specific embodiments of sorbent bed-powder combination embodiments of the process of the present invention, the Group A particles of the sorbent powder and the Group A particles contained in the sorbent bed have essentially the same composition.

According to certain specific embodiments of sorbent bed-powder combination embodiments of the process of the present invention, the Group A particles of the sorbent powder and the Group A particles contained in the sorbent bed have different compositions.

According to certain embodiments of the process of the present invention (hereinafter “hybrid embodiments”), the process further comprises:

(I′) providing a plurality of Group B particles of a Group B sorbent material having a composition differing from that of the Group A sorbent material; and

(II′) contacting the fluid stream with a plurality of Group B particles of the Group B sorbent material.

According to certain specific embodiments of the hybrid embodiments of the process of the present invention, the Group B sorbent material comprises an activated carbon matrix defining a plurality of pores and is essentially free of sulfur.

According to certain specific embodiments of the hybrid embodiments of the process of the present invention, the Group B sorbent material comprises an activated carbon matrix defining a plurality of pores and is essentially free of the additive contained in the Group A sorbent material.

According to certain specific embodiments of the hybrid embodiments of the process of the present invention, the Group B sorbent material consists essentially of activated carbon.

According to certain specific embodiments of the hybrid embodiments of the process of the present invention:

in step (II), at least part of the plurality of Group A particles are contained in a sorbent bed; and

in step (II′), at least part of the plurality of Group B particles are introduced into the fluid stream at a Group B particle introduction location in the form of sorbent powder;

the Group B particles of the sorbent powder are allowed to travel with the fluid stream to a downstream Group B particle collecting location; and

the process further comprises a step (III′) as follows:

(III′) collecting at least part of the Group B particles of the sorbent powder at the Group B particle collecting location.

According to certain specific embodiments of the hybrid embodiments of the process of the present invention:

in step (II′), at least part of the plurality of Group B particles are contained in a sorbent bed; and

in step (II′), at least part of the plurality of Group A particles are introduced into the fluid stream at a Group A particle introduction location in the form of sorbent powder;

the Group A particles of the sorbent powder are allowed to travel with the fluid stream to a downstream Group A particle collecting location; and

the process further comprises a step (III) as follows:

(III) collecting at least part of the Group A particles of the sorbent powder at the Group A particle collecting location.

According to certain specific embodiments of the hybrid embodiments of the process of the present invention, steps (II) and (II′) are carried out at least partly simultaneously.

According to certain embodiments of the hybrid embodiments of the process of the present invention, steps (III) and (III′) are carried out at least partly simultaneously at least partly at the same location.

According to certain embodiments of the process of the present invention, sulfur is distributed throughout the activated carbon matrix of the Group A sorbent material.

According to certain embodiments of the process of the present invention, the additive is essentially homogeneously distributed in the activated carbon matrix of the Group A sorbent material.

According to certain embodiments of the process of the present invention, sulfur is essentially homogeneously distributed in the activated carbon matrix of the Group A sorbent material.

According to certain embodiments of the process of the present invention, in the Group A sorbent material, at least part of sulfur is present in a state capable of chemically bonding with Hg. In certain specific embodiments, in the Group A sorbent material, at least 10% of the sulfur on the surface of the walls of the pores is essentially at zero valency when measured by XPS.

According to certain embodiments of the process of the present invention, in the Group A sorbent material, the additive is selected from: (i) halides, oxides and hydroxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; and (iv) combinations and mixtures of two or more of (i), (ii) and (iii).

According to certain embodiments of the process of the present invention, in the Group A sorbent material, the additive is selected from: (i) oxides, sulfides and salts of manganese; (ii) oxides, sulfides and salts of iron; (iii) combinations of (i) and KI; (iv) combinations of (ii) and KI; and (v) mixtures and combinations of any two or more of (i), (ii), (iii) and (iv).

According to certain embodiments of the process of the present invention, the Group A sorbent material comprises an alkaline earth hydroxide.

According to certain embodiments of the process of the present invention, the Group A sorbent material comprises at least 91% by weight of activated carbon, sulfur and the additive.

According to certain embodiments of the process of the present invention, the Group A sorbent material comprises from 50% to 97% by weight of carbon.

According to certain embodiments of the process of the present invention, the Group A sorbent material comprises 1% to 20% by weight of sulfur.

According to certain embodiments of the process of the present invention, the Group A sorbent material comprises from 1% to 25% by weight of the additive.

According to certain embodiments of the process of the present invention, the Group A sorbent material has an initial Hg removal efficiency of at least 91% with respect to RFG1.

According to certain embodiments of the process of the present invention, the Group A sorbent material has an initial Hg removal efficiency of at least 91% with respect to to RFG2.

According to certain embodiments of the process of the present invention, the Group A sorbent material has an initial Hg removal efficiency of at least 91% with respect to RFG3.

According to certain embodiments of the process of the present invention, the Group A sorbent material has a Hg removal capacity of at least 0.10 mg·g⁻¹ with respect to RFG1.

According to certain embodiments of the process of the present invention, the Group A sorbent material has a Hg removal capacity of at least 0.10 mg·g⁻¹ with respect to RFG2.

According to certain embodiments of the process of the present invention, the Group A sorbent material has a Hg removal capacity of at least 0.10 mg·g⁻¹ with respect to RFG3.

According to certain embodiments of the process of the present invention, the fluid stream is a gas stream comprising mercury and at least 10% by mole of the mercury in the fluid stream is in elemental state.

According to certain embodiments of the process of the present invention, the fluid stream is a gas stream comprising mercury and at least 50% by mole of the mercury in the gas stream is in elemental state.

According to certain embodiments of the process of the present invention, the fluid stream is a gas stream comprising mercury and less than 50 ppm by volume of HCl.

According to certain embodiments of the process of the present invention, the fluid stream is a gas stream comprising mercury and at least 3 ppm by volume of SO₃.

According to certain embodiments of the process of the present invention, the fluid stream is a gas stream comprising mercury and at least 3 ppm by volume of SO₃.

According to a second aspect of the present invention, provided is a process for making particles of a sorbent material comprising an activated carbon matrix defining a plurality of pores; sulfur; and an additive adapted for promoting the removal of at least one of As, Cd, Hg and Se from a fluid stream, wherein the additive is distributed throughout the activated carbon matrix; comprising:

(a) providing a plurality of batch-mixture particles comprising a carbon-source material, a sulfur-source material, an additive-source material and an optional filler material, wherein the additive-source material is substantially homogeneously distributed in the particles;

(b) carbonizing the batch mixture particles by subjecting the batch mixture particle to an elevated carbonizing temperature in an O₂-depleted atmosphere to obtain a carbonized batch mixture body; and

(c) activating the carbonized batch mixture particles at an elevated activating temperature in a CO₂ and/or H₂O-containing atmosphere.

According to certain embodiments of the process of the second aspect of the present invention, step (a) comprises:

(a1) mixing a carbon-source material, a sulfur-source material, an additive-source material and an optional filler material to obtain an essentially uniform mixture;

(a2) forming wet particles from the mixture; and

(a3) drying the wet particles to obtain dry batch-mixture particles.

Certain embodiments of the present invention have one or more of the following advantages. First, certain embodiments of the process can have a very high initial Hg removal efficiency and a very high Hg removal capacity. Second, certain embodiments of the process of the present invention can be effective for sorption of not just oxidized mercury, but also elemental mercury. Further, the process according to certain embodiments of the present invention can be effective in removing mercury from flue gases with high and low concentrations of HCl alike. Fourth, the process according to certain embodiments of the present invention can be effective in removing mercury from flue gases with high concentration of SO₃. Last but not least, the process according to certain embodiments of the process of the present invention can be conveniently employed by coal-burning plant plants having pre-existing ACI equipment.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a diagram comparing the mercury removal capability of a tested sample of a sorbent comprising an in-situ extruded additive according to the present invention and a sorbent which comprises impregnated additive but no in-situ extruded additive over time.

FIG. 2 is a diagram showing the inlet mercury concentration (CHg0) and outlet mercury concentration (CHg1) of a sorbent body according to one embodiment of the present invention at various inlet mercury concentration.

FIG. 3 is an SEM image of part of a cross-section of a precursor sorbent body according to the present invention comprising in-situ extruded additive.

FIG. 4 is an SEM image of part of a cross-section of a comparative sorbent body comprising post-activation impregnated additive.

FIG. 5 is a diagram schematically illustrating the apparatus set-up implementing an embodiment of the process of the present invention.

### DETAILED DESCRIPTION OF THE INVENTION

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, in describing and claiming the present invention, the use of the indefinite article “a” or “an” means “at least one,” and should not be limited to “only one” unless explicitly indicated to the contrary. Thus, for example, reference to “a mercury containing compound” includes embodiments having two or more such mercury containing compounds, unless the context clearly indicates otherwise.

As used herein, a “wt %” or “weight percent” or “percent by weight” of a component, unless specifically stated to the contrary, is based on the total weight of the composition or article in which the component is included. As used herein, all percentages are by weight unless indicated otherwise. All ppm with respect to gases are by volume unless indicated otherwise.

In the present application, each element present in the sorbent body and/or sorbent material is referred to in the collective, including any such element at any oxidation state, unless indicated otherwise. Thus, the term “sulfur” as used herein includes sulfur element at all oxidation states, including, inter alia, elemental sulfur (0), sulfate (+6), sulfite (+4), and sulfide (−2). Thus, percentages of sulfur is calculated on the basis of elemental sulfur, with any sulfur in other states converted to elemental state for the purpose of calculation of the total amount of sulfur in the material. Percentages of an additive is calculated on the basis of elemental metal, with any metal in other states converted to elemental state for the purpose of calculation of the total amount of additive in the material.

By “in-situ extruded” is meant that the relevant material, such as sulfur and/or additive, is introduced into the body by incorporating at least part of the source material thereof into the batch mixture material, such that the extruded body comprises the source materials incorporated therein.

The Group A particles of the sorbent body to be used in the process of the present invention may be directly produced as Group A particles with desired particle size and size distribution by using various in-situ manufacture process, or by pulverizing larger precursor sorbent bodies, such as pellets, honeycombs and other monoliths. The precursor sorbent bodies are desired to have essentially the same chemical composition and key physical properties, such as overall porosity, and the like, as the Group A particles to be used in the various embodiments of the process of the present invention. Thus, characterization of the composition and the physical properties of the Group A particles may be carried out with respect to the particles per se, or to the precursor sorbent bodies.

Distribution of sulfur, additive or other materials across a cross-section of a sorbent body, a particle of a Group A sorbent material, or an extrusion batch mixture body, or a batch mixture material of the present invention can be measured by various techniques, including, but not limited to, microprobe, XPS (X-ray photoelectron spectroscopy), and laser ablation combined with mass spectroscopy.

The methodology of characterizing the distribution of a certain material (e.g., sulfur, an additive, and the like) in a certain planar cross-section of a precursor sorbent body, a particle, or other body, is described as follows. This methodology is referred to as “Distribution Characterization Method” in the present application.

Target test areas of the cross-section of at least 500 μm×500 μm size are chosen if the total cross-section is larger than 500 μm×500 μm. The full cross-section, if less than or equal to 500 μm×500 μm, would be a single target test area. The total number of target test areas is p (a positive integer).

Each target test area is divided by a grid into multiple separate 20 μm×20 μm zones. Only zones having an effective area (defined below) not less than 40 μm² are considered and those having an effective area lower than 40 μm² are discarded in the data processing below. Thus the total effective area (ATE) of all the square sample zones of the target test area is:

$$A T E = {\sum }_{i = 1}^{n} ae ( i ) ,$$

where ae(i) is the effective area of zone i, and n is the total number of the square sample zones in the target test area, where ae(i)≧40 μm². Area of individual square zone ae(i) in square micrometers is calculated as follows:

ae(i)=400−av(i),

where av(i) is the total area in square micrometers of any voids, pores or free space larger than 10 μm² within square zone i.

Each square zone i is measured to have an average concentration C(i), expressed in terms of moles of sulfur atoms per unit effective area for sulfur, or moles of other relevant material in the case of an additive. All C(i) (i=1 to n) are then listed in descending order to form a permutation CON(1), CON(2), CON(3), . . . CON(n), where CON(1) is the highest C(i) among all n zones, and CON(n) is the lowest C(i) among all n zones. The arithmetic average concentration of the 5% of all n zones in the target test area having the highest concentrations is CON(max). Thus:

$$CON ( max ) = \frac{{\sum }_{m = 1}^{INT ( 0.05 \times n )} CON ( m )}{INT ( 0.05 \times n )} ,$$

where INT(0.05×n) is the smallest integer larger than or equal to 0.05×n. As used herein, the operator “INT(X)” yields the smallest integer larger than or equal to X.

The arithmetic average concentration of the 5% of all n zones in the target test area having the lowest concentrations is CON(min). Thus:

$$CON ( min ) = \frac{{\sum }_{m = INT ( 0.95 \times n )}^{n} CON ( m )}{n - INT ( 0.95 \times n )} .$$

The arithmetic average concentration of the target test area is CON(av). Thus:

$$CON ( av ) = \frac{{\sum }_{m = 1}^{n} CON ( m )}{n} .$$

For all p target test areas, all CON(av)(k) (k=1 to p) are then listed in descending order to form a permutation CONAV(1), CONAV(2), CONAV(3), . . . CONAV(p), where CONAV(1) is the highest CON(av)(k) among all p target test areas, and CONAV(p) is the lowest CON(av)(p) among all p target test areas. The arithmetic average concentration of all p target test areas is CONAV(av). Thus:

$$CONAV ( av ) = \frac{{\sum }_{k = 1}^{p} CONAV ( k )}{p} .$$

In certain Group A sorbent materials that can be used in certain embodiments of the process of the present invention, as particle, precursor sorbent body, or both, where the relevant material is distributed throughout the body, or the activated carbon matrix, or the material, it is desired that: in each target test area, the distribution thereof has the following feature: CON(av)/CON(min)≦30, and CON(max)/CON(av)≦30. In certain other embodiments, it is desired that CON(av)/CON(min)≦20, and CON(max)/CON(av)≦20. In certain other embodiments, it is desired that CON(av)/CON(min)≦15, and CON(max)/CON(av)≦15. In certain other embodiments, it is desired that CON(av)/CON(min)≦10, and CON(max)/CON(av)≦10. In certain other embodiments, it is desired that CON(av)/CON(min)≦5, and CON(max)/CON(av)≦5. In certain other embodiments, it is desired that CON(av)/CON(min)≦3, and CON(max)/CON(av)≦3. In certain other embodiments, it is desired that CON(av)/CON(min)≦2, and CON(max)/CON(av)≦2.

For a certain material or component to be “homogeneously distributed” to have a “homogeneous distribution” in a body or a material according to the present application, the distribution thereof according to the Distribution Characterization Method satisfies the following: in each target test area, for all CON(m) where 0.1n≦m≦0.9n: 0.5≦CON(m)/CON(av)≦2. In certain embodiments, it is desired that 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments, for all CON(m) where 0.05n≦m≦0.95n: 0.5≦CON(m)/CON(av)≦2; in certain embodiments, 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments of the bodies (precursor sorbent body, extrusion mixture body, particles, and the like) and material useful for certain embodiments of the process of the present invention, in addition to any one of the features stated above in this paragraph with respect to each individual target test area, the distribution of the relevant material (e.g., sulfur, an additive, and the like) with respect to all p target test areas has the following feature: for all CONAV(k) where 0.1p≦k≦0.9p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05. In certain embodiments, for all CONAV(k) where 0.05p≦k≦0.95p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05.

In certain embodiments, the particles of the Group A sorbent material is injected into the fluid stream, such as flue gas stream of a steam-generator of a coal-burning plant at a certain location of the flue gas stream pathway (Group A particle introduction location), allowed to travel with the flue gas in the pipeline, then collected at a downstream location (Group A particle collecting location). This embodiment is similar to the conventional ACI technology in terms of process implementation, with the distinction that the particles of Group A sorbent material have higher initial Hg removal efficiency and a higher Hg removal capacity than conventional activated carbon powder. The particles of the Group A sorbent material can be injected into the flue gas stream with a carrier gas. The particles, during the travel in the pipeline, comingle with the flue gas and sorbs toxic metals such as Hg, As, Cd and Se. Particle size for this powder embodiment typically ranges from 1 to 200 μm; in certain embodiments from 5 to 100 μm; in certain other embodiments from 5 to 30 μm. However, if the particles are too fine, they may be difficult to collect at the collecting location by using conventional dust collecting equipment such as an electrostatic precipitator.

In certain embodiments (“sorbent bed embodiments”), the particles of the Group A sorbent material is contained in a sorbent bed installed in the middle of the pathway of the fluid stream to be treated. As mentioned supra, the particles may maintain essentially stationery during the fluid treatment process, thus the bed is essentially a packed bed. In other embodiments, the particles are contained in a fluidized bed. In a fluidized bed, the fluid stream such as a flue gas stream, enters into the bed with sufficient velocity such that the particles confined therein move within the bed and essentially maintained suspended within the fluid stream. Group A particles for use in packed sorbent bed typically have an average particle size ranging from 5 to 1000 μm; in certain embodiments from 10 to 200 μm; in certain other embodiments from 10 to 100 μm. Group A particles for use in fluidized bed typically have an average particle size ranging from 1 to 200 μm; in certain embodiments from 1 to 100 μm; in certain other embodiments from 1 to 50 μm; in certain other embodiments from 1 to 20 μm.

In certain other embodiments (powder-sorbent-bed combination embodiments), part of the Group A particles are injected into the fluid stream to be treated as in the powder embodiments, and part of the Group A particles are contained in a sorbent bed such as a fluidized bed or a packed bed as in the sorbent bed embodiments. It is preferred in certain powder-sorbent-bed combination embodiments that the sorbent bed containing and confining the Group A particles is a fluidized sorbent bed. In some of these combination embodiments, the Group A particles for traveling in the pipleline without being confined to a sorbent bed tends to have smaller size than those confined and contained in the sorbent bed. Such smaller “flying” particles can advantageously travel through the sorbent bed in certain embodiments. It is believed that if the flying particles travel through the sorbent bed, collisions between and among the particles can take place. It is also believed that the collisions may lead to the aggregation of some of the flying particles, causing the average size of the flying particles exiting the sorbent bed to enlarge. This can be advantageous in that enlarged particles tend to be easier to capture and collect by conventional dust collectors such as an electrostatic precipitator.

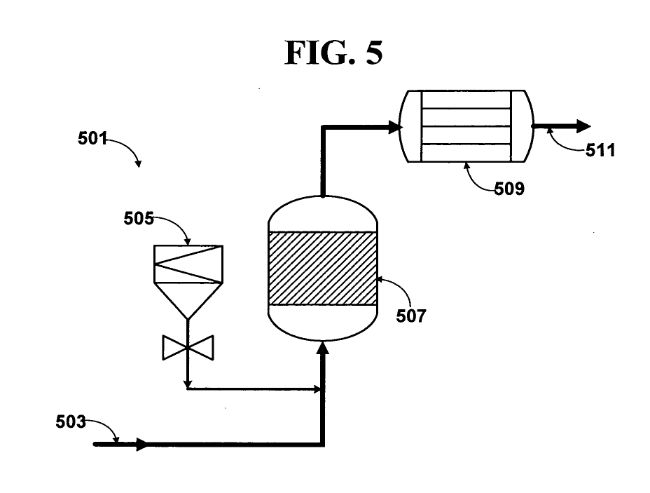

FIG. 5 schematically illustrates an apparatus 501 implementing an powder-sorbent-bed combination embodiment of the present invention. In this figure, a stream of Group A particles 505 is injected into a flue gas stream 503. The admixture then enters into a fluidized or packed sorbent bed 507. Particles are subsequently collected at a downstream collecting location by an electrostatic precipitator 509. A cleaned flue gas 511 exits the electrostatic precipitator 509.

In the powder-sorbent-bed combination embodiments, the particles contained in the sorbent bed and those not contained in the bed can have the same or differing average composition.

It is also contemplated that the Group A particles may be used in conjunction with certain Group B particles having differing compositions. For example, the Group B particles may consist essentially of activated carbon in certain embodiments. The Group B particles may be essentially free of sulfur or the additive contained in the Group A sorbent material. Use of both Group A and Group B particles can potentially reduce the overall cost of the process.

As can be imagined, the Group A particles and Group B particles may be used as an intimate admixture, or separately injected at different locations of the fluid stream pathway. Alternatively, the Group A and Group B particles can be used as flying particles (particles not confined or contained in a sorbent bed) and fixed particles (particles confined and contained in a sorbent bed) in an embodiment similar to the powder-sorbent-bed combination embodiments described above in connection with process embodiments using Group A sorbent materials only, with various combinations thereof.

The Group A sorbent material useful for the process of the present invention is adapted for removing mercury and other toxic elements from a fluid stream, such as a flue gas stream resulting from coal combustion or waste incineration or syngas produced during a coal gasification process. As described supra, it is generally known that such gas streams, before any abatement procedure is undertaken, contain various amounts of mercury and/or other toxic elements such as As, Cd and Se. Mercury abatement for those gas streams is one of the major environmental concerns. Mercury can be present in elemental state or oxidized state at various proportions in such gas streams depending on the source material (e.g., bituminous coal, sub-bituminous coal, municipal waste, and medical waste) and process conditions.

The Group A sorbent material useful for the present invention comprises an activated carbon matrix, sulfur and an additive adapted for promoting the removal of arsenic, cadmium, mercury and/or selenium from the fluid stream to be treated. The additive comprises a metal element. It is believed that, by a combination of a physical and chemical sorption, the Group A sorbent material is capable of binding and trapping mercury both at elemental state and oxidized state. The sorbent bodies and material useful for certain embodiments of the present invention are particularly effective for removing mercury at elemental state in a flue gas stream. This is particularly advantageous compared to certain prior art technology (such as conventional ACI technology) which is usually less effective in removing elemental mercury.

The precursor sorbent body useful for the present invention may take various shapes. For example, the precursor sorbent body may be a powder, a pellet, a cast body, and/or an extruded monolith. The precursor sorbent body and particles useful for the present invention may be incorporated in a fixed sorbent bed through which the fluid stream to be treated flows. In certain applications, especially in treating the coal combustion flue gas in power plants or the syngas produced in coal gasification processes, it is highly desired that any fixed bed through which the gas stream passes has a low pressure-drop. To that end, it is desired that sorbent particles packed in the fixed bed allow for sufficient gas passageways. In certain embodiments, it is particularly advantageous that the precursor sorbent material useful for the process of the present invention is in the form of extruded monolithic honeycomb having multiple channels. Cell density of the honeycomb can be adjusted during the extrusion process to achieve various degree of pressure-drop when in use. Cell density of the honeycomb can range from 25 to 500 cells·inch⁻² (3.88 to 77.5 cells·cm⁻²) in certain embodiments, from 50 to 200 cells·inch⁻² (7.75 to 31.0 cells·cm⁻²) in certain other embodiments, and from 50 to 100 cells·inch⁻² (7.75 to 15.5 cells·cm⁻²) in certain other embodiments. To allow for more intimate contact between the gas stream and the sorbent material, it is desired in certain embodiments that part of the channels are plugged at one end of the sorbent body, and part of the channels are plugged at the other end of the sorbent body. In certain embodiments, it is desired that at each end of the sorbent body, the plugged and/or unplugged channels form a checkerboard pattern. In certain embodiments, it is desired that where one channel is plugged on one end (referred to as “the reference end”) but not the opposite end of the sorbent body, at least a majority of the channels (preferably all in certain other embodiments) immediately proximate thereto (those sharing at least one wall with the channel of concern) are plugged at the other end of the sorbent body but not on the reference end. Multiple honeycombs can be stacked in various manners to form actual sorbent beds having various sizes, service duration, and the like, to meet the needs of differing use conditions.

Activated carbon, owing to its typically high specific area, has been used for abating mercury from flue gas stream of coal power plants. However, as described supra, activated carbon alone does not have sufficient removal capability. Using a combination of sulfur and activated carbon for mercury abatement was known. Whereas such combination does provide modest improvement over activated carbon alone in terms of mercury abatement capability, sorbent material having even higher mercury abatement efficiency and capacity, especially when used in a fixed bed, is highly desired.

The “activated carbon matrix,” as used herein, means a network formed by interconnected carbon atoms and/or particles in the sorbent body, sorbent material or powder useful for the present invention. As is typical for activated carbon materials, the matrix comprises wall structure defining a plurality of interconnected pores. The activated carbon matrix, along with sulfur and the additive, provides the backbone structure of the sorbent body and/or sorbent material. In addition, the large cumulative areas of the pores in the activated carbon matrix provide a plurality of sites where mercury sorption can occur directly, or where sulfur and the additive can be distributed, which further promote mercury sorption. It is to be noted that the pores defined by the activated carbon matrix can be different from the pores actually present in the sorbent body or sorbent matrix useful for the present invention. Part of the pores defined by the activated carbon matrix may be filled by an additive, sulfur, an inorganic filler, and combinations and mixtures thereof.

The Group A sorbent material useful for certain embodiments of the process of the present invention comprises from 50% to 97% by weight of carbon, in certain embodiments from 60% to 97%, in certain other embodiments from 85% to 97%. Higher concentration of carbon usually leads to higher porosity at the same level of carbonization and activation according to a process for making such bodies to be detailed infra.

The pores defined by the activated carbon matrix in the sorbent material useful for the process of the present invention are divided into two categories: nanoscale pores having a diameter of less than or equal to 10 nm, and microscale pores having a diameter of higher than 10 nm. Pore size and distribution thereof in the sorbent material useful for the process of the present invention can be measured by using techniques available in the art, such as, e.g., nitrogen adsorption. Both the surfaces of the nanoscale pores and the microscale pores together provide the overall high specific area of the sorbent material useful for the process of the present invention. In certain embodiments of the sorbent material useful for the process of the present invention, the wall surfaces of the nano scale pores constitute at least 50% of the specific area of the sorbent body and/or sorbent material. In certain other embodiments, the wall surfaces of the nanoscale pores constitute at least 60% of the specific area of the sorbent body and/or sorbent material. In certain other embodiments, the wall surfaces of the nanoscale pores constitute at least 70% of the specific area of the sorbent body and/or sorbent material. In certain other embodiments, the wall surfaces of the nanoscale pores constitute at least 80% of the specific area of the sorbent body and/or sorbent material. In certain other embodiments, the wall surfaces of the nanoscale pores constitute at least 90% of the specific area of the sorbent body and/or sorbent material.

The sorbent bodies and/or sorbent materials useful for the present invention are characterized by large specific surface area. In certain embodiments of the present invention, the sorbent bodies and/or sorbent materials have specific areas ranging from 50 to 2000 m²·g⁻¹. In certain other embodiments, the sorbent bodies and/or sorbent materials useful for the present invention have specific areas ranging from 100 to 1800 m²·g⁻¹. In certain other embodiments, the sorbent bodies and/or sorbent materials useful for the present invention have specific areas ranging from 200 to 1500 m²·g⁻¹. In certain other embodiments, the sorbent bodies and/or sorbent materials useful for the present invention have specific areas ranging from 300 to 1200 m²·g⁻¹. Higher specific area of the sorbent body and/or sorbent material can provide more active sites in the material for the sorption of toxic elements. However, if the specific area of the sorbent body and/or sorbent material is quite high, e.g., higher than 2000 m²·g⁻¹, the sorbent body and/or sorbent material becomes quite porous and the mechanical integrity of the sorbent body suffers. This could be undesirable for certain embodiments where the strength of the sorbent body needs to meet certain threshold requirement.

As indicated supra and infra, the sorbent bodies and/or sorbent materials useful for the process of the present invention may comprise a certain amount of inorganic filler materials. In order to obtain a high specific surface area of the sorbent body and/or sorbent material, it is even desired that, if inorganic fillers are included, such inorganic fillers in and of themselves are porous and contribute partly to the high specific area of the sorbent body and/or sorbent material. Nonetheless, as indicated supra, most of the high specific area of the sorbent material useful for the process of the present invention are provided by the pores, especially the nanoscale pores, of the activate carbon matrix. Inorganic fillers having specific surface area comparable to that of the activated carbon is usually difficult or costly to be included in the sorbent material useful for the process of the present invention. Therefore, along with the typical mechanical reinforcement such inorganic fillers would bring to the final sorbent body and/or sorbent material, it also tends to compromise the overall specific area of the sorbent body and/or sorbent material. This can be highly undesirable in certain embodiments. As indicated supra, a high surface area of the sorbent body and/or sorbent material usually means more active sites (including carbon sites capable of sorption of the toxic elements, sulfur capable of promoting or direct sorption of the toxic elements, and the additive capable of promoting sorption of the toxic elements) for the sorption of the toxic elements. It is further believed that close proximity of the three categories of active sorption sites in the sorbent body and/or sorbent material is conducive to the overall sorption capability. The incorporation of large amounts of inorganic fillers dilutes the additive and sulfur in the carbon matrix, adding to the overall average distances between and among these three categories of active sites. Hence, it is desired that the Group A sorbent material useful for the process of the present invention has a relative low percentage of inorganic materials other than carbon, sulfur-containing inorganic materials and the additive. In certain embodiments of the Group A sorbent material useful for the process of the present invention, it is desired that the material comprises less than 10% (in certain embodiments less than 8%, in certain other embodiments less than 5%, in certain other embodiments less than 3%, in certain other embodiments less than 2%) by weight of inorganic materials other than carbon, sulfur-containing inorganic material and the additive.

The additive contained in the Group A sorbent material typically comprises a metallic element. Any additive capable of promoting the removal of toxic elements or compounds, especially mercury, arsenic, cadmium or selenium, from the fluid stream to be treated upon contacting can be included in the sorbent material useful for the process of the present invention. The additive can function in one or more of the following ways, inter alia, to promote the removal of such toxic elements: (i) temporary or permanent chemical sorption (e.g., via covalent and/or ionic bonds) of a toxic element; (ii) temporary or permanent physical sorption of a toxic element; (iii) catalyzing the reaction/sorption of a toxic element with other components of the sorbent material; (iv) catalyzing the reaction of a toxic element with the ambient atmosphere to convert it from one form to another; (v) trapping a toxic element already sorbed by other components of the sorbent body and/or sorbent material; and (vi) facilitating the transfer of a toxic element to the active sorbing sites. Precious metals (Ru, Th, Pd, Ag, Re, Os, Ir, Pt and Au) and transition metals and compounds thereof are known to be effective for catalyzing such processes. Non-limiting examples of additives that can be included in the sorbent material useful for the process of the present invention include: precious metals listed above and compounds thereof; alkali and alkaline earth halides, hydroxides or oxides; and oxides, sulfides, and salts of vanadium, chromium, manganese, iron, cobalt, nickel, copper, zinc, niobium, molybdenum, silver, tungsten, and lanthanoids. The metallic elements in the additive(s) can be at various valencies. For example, if iron is included in the additive, it may be present at +3, +2 or 0 valencies or as mixtures of differing valencies, and can be present as metallic iron (0), FeO, Fe₂O₃, Fe₃O₈, FeS, FeCl₂, FeCl₃, FeSO₄, and the like. For another example, if manganese is present in the additive, it may be present at +4, +2 or 0 valencies or as mixtures of differing valences, and can be present as metallic manganese (0), MnO, MnO₂, MnS, MnCl₂, MnCl₄, MnSO₄, and the like.

In certain embodiments of the Group A sorbent material useful for the process of the present invention, the additive(s) included advantageously are: alkali halides; and oxides, sulfides and salts of manganese and iron. In certain embodiments of the sorbent bodies and/or sorbent materials useful for the present invention, the additive(s) included advantageously are: combination of KI and oxides, sulfides and salts of manganese; combination of KI and oxides, sulfides and salts of iron; or a combination of KI, oxides, sulfides and salts of manganese and iron. These combinations are found to be particularly effective in removing mercury, especially elemental mercury from a gas stream.

According to certain embodiments of the present invention, the Group A sorbent material and/or a precursor sorbent body thereof comprise an alkaline earth metal hydroxide as an additive for promoting the removal of toxic elements, such as Ca(OH)₂. Experiments have shown that Ca(OH)₂ can be particularly effective in promoting the removal of arsenic, cadmium and selenium from a gas stream.

The amount of the additive present in the Group A sorbent material and/or precursor sorbent body thereof useful for the present invention can be selected, depending on the particular additive used, and application for which the sorbent bodies are used, and the desired toxic element removing capacity and efficiency of the sorbent material. In certain embodiments of the Group A sorbent materials useful for the present invention, the amount of the additive ranges from 1% to 20% by weight of the total weight of the material, in certain other embodiments from 2% to 18%, in certain other embodiments from 5% to 15%, in certain other embodiments from 5% to 10%.

If only one additive is present in the Group a sorbent material useful for the process of the present invention, it is distributed throughout the activated carbon matrix. If multiple additives are present, at least one of them is distributed throughout the activated carbon matrix. By “distributed throughout the activated carbon matrix” is meant that the relevant specified material (additive, sulfur, and the like) is present not just on the external surface of the sorbent body and/or sorbent material or cell walls, but also deep inside the sorbent body and/or sorbent material. Thus the presence of the specific additive can be, e.g.: (i) on the wall surfaces of nanoscale pores defined by the activated carbon matrix; (ii) on the wall surfaces of microscale pores defined by the activated carbon matrix; (iii) submerged in the wall structure of the activated carbon matrix; (iv) partly embedded in the wall structure of the activated carbon matrix; (v) partly fill and/or block some pores defined by the activated carbon matrix; and (vi) completely fill and/or block some pores defined by the activated carbon matrix. In situations (iii), (iv), (v) and (vi), the additive(s) actually forms part of the wall structure of the pores of the sorbent body and/or sorbent material. In certain embodiments of the sorbent material useful for the process of the present invention, multiple additives are present and all of them are distributed throughout the activated carbon matrix. However, it is not required that all additives are distributed throughout the activated carbon matrix in all embodiments of the sorbent material useful for the process of the present invention. Thus, in certain embodiments of the sorbent material useful for the process of the present invention, multiple additives are present, with at least one of them distributed throughout the activated carbon matrix, and at least one of them distributed essentially mainly on the external surface area and/or cell wall surface of the sorbent body and/or sorbent material, and/or within a thin layer beneath the external surface area and/or cell wall surface. Therefore, in certain embodiments, part of the additive may be chemically bonded with other components of the sorbent body and/or sorbent material, such as carbon or sulfur. In certain other embodiments, part of the additive may be physically bonded with the activated carbon matrix or other components. Still in certain other embodiments, part of the additive is present in the sorbent body and/or sorbent material in the form of particles having nanoscale or microscale size.

Distribution of an additive in a sorbent body and/or sorbent material or other body or material useful for the present invention can be measured and characterized by the Distribution Characterization Method described supra. In certain embodiments of the Group A sorbent material or a sorbent body thereof useful for the process of the present invention, the distribution of an additive has the following feature: in each target test area, CON(av)/CON(min)≦30, and CON(max)/CON(av)≦30. In certain other embodiments, it is desired that CON(av)/CON(min)≦20, and CON(max)/CON(av)≦20. In certain other embodiments, it is desired that CON(av)/CON(min)≦15, and CON(max)/CON(av)≦15. In certain other embodiments, it is desired that CON(av)/CON(min)≦10, and CON(max)/CON(av)≦10. In certain other embodiments, it is desired that CON(av)/CON(min) δ 5, and CON(max)/CON(av) δ 5. In certain other embodiments, it is desired that CON(av)/CON(min) δ 3, and CON(max)/CON(av) δ 3. In certain other embodiments, it is desired that CON(av)/CON(min)≦2, and CON(max)/CON(av)≦2.

In certain embodiments of the Group A sorbent material or a sorbent body thereof useful for the process of the present invention, at least one additive is homogeneously distributed throughout the activated carbon matrix according to the Distribution Characterization Method described supra. Thus, in each target test area, for all CON(m) where 0.1n≦m≦0.9n: 0.5≦CON(m)/CON(av)≦2. In certain embodiments, it is desired that 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments, for all CON(m) where 0.05n≦m≦0.95n: 0.5≦CON(m)/CON(av)≦2; in certain embodiments, 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments of the Group A material and/or a sorbent body thereof, in addition to any one of the features stated above in this paragraph with respect to each individual target test area, the distribution of the relevant material (e.g., sulfur, an additive, and the like) with respect to all p target test areas has the following feature: for all CONAV(k) where 0.1p≦k≦0.9p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05. In certain embodiments, for all CONAV(k) where 0.05p≦k≦0.95p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05.

In certain embodiments of the present invention, the additive is present on a majority of the wall surfaces of the microscale pores of the Group A sorbent material and/or a precursor sorbent body thereof useful for the present invention. In certain other embodiments of the present invention, the additive is present on at least 75% of the wall surfaces of the microscale pores. In certain other embodiments of the present invention, the additive is present on at least 90% of the wall surfaces of the microscale pores. In certain other embodiments of the present invention, the additive is present on at least 95% of the wall surfaces of the microscale pores.

In certain embodiments of the present invention, the additive is present on at least 20% of the wall surfaces of the nanoscale pores of the Group A sorbent material and/or a precursor sorbent body thereof useful for the present invention. In certain other embodiments of the present invention, the additive is present on at least 30% of the wall surfaces of the nanoscale pores. In certain other embodiments of the present invention, the additive is present on at least 40% of the wall surfaces of the nanoscale pores. In certain other embodiments of the present invention, the additive is present on at least 50% of the wall surfaces of the nanoscale pores. In certain other embodiments of the present invention, the additive is present on at least 75% of the wall surfaces of the nanoscale pores. In certain other embodiments of the present invention, the additive is present on at least 85% of the wall surfaces of the nanoscale pores. In certain embodiments of the present invention, a majority of the specific area of the sorbent body and/or sorbent material is provided by the wall surfaces of the nanoscale pores. In these embodiments, it is desired that a higher percentage of the wall surface of the nanoscale pores has the additive distributed thereon.

The Group A sorbent material useful for the process of the present invention comprises sulfur. Sulfur may be present in the form of elemental sulfur (0 valency), sulfides (−2 valency, e.g.), sulfite (+4 valency, e.g.), sulfate (+6 valency, e.g.). It is desired that at least part of the sulfur is present in a valency capable of chemically bonding with the toxic element to be removed from the fluid stream. To that end, it is desired that at least part of the sulfur is present at −2 and/or zero valency. Part of sulfur may be chemically or physically bonded to the wall surface of the activated carbon matrix. Part of the sulfur may be chemically or physically bonded to the additive, as indicated supra, e.g., in the form of a sulfide (FeS, MnS, Mo₂S₃, and the like). In certain embodiments, it is desired that at least 40% by mole of the sulfur in the sorbent body and/or sorbent material be at zero valency. In certain other embodiments, it is desired that at least 50% by mole of the sulfur in the sorbent body and/or sorbent material be at zero valency. In certain other embodiments, it is desired that at least 60% by mole of the sulfur in the sorbent body and/or sorbent material be at zero valency. In certain other embodiments, it is desired that at least 70% by mole of the sulfur in the sorbent body and/or sorbent material be at zero valency.

Experiments have demonstrated that sulfur-infused activated carbon can be effective for removing arsenic, cadmium as well as selenium, in addition to mercury, from a gas stream. Experiments have demonstrated that sorbent bodies comprising elemental sulfur tend to have higher mercury removal capability than those without elemental sulfur but with essentially the same total sulfur concentration.

The amount of sulfur present in the sorbent bodies and/or sorbent materials useful for the present invention can be selected, depending on the particular additive used, and application for which the sorbent bodies are used (in packed bed, fluidized bed, or as flying particles, e.g.), and the desired toxic element removing capacity and efficiency of sorbent body and/or sorbent material. In certain embodiments of the sorbent bodies and/or sorbent materials useful for the present invention, the amount of sulfur ranges from 1 to 20% by weight of the total weight of the bodies/materials, in certain embodiments from 1 to 15%, in certain other embodiments from 2% to 10%, in certain other embodiments from 3% to 8%.

In certain embodiments of the present invention, sulfur is distributed throughout the activated carbon matrix. By “distributed throughout the activated carbon matrix” is meant that sulfur is present not just on the external surface of the sorbent body and/or sorbent material or cell walls, but also deep inside the sorbent body and/or sorbent material and/or cell wall skeleton thereof. Thus the presence of sulfur can be, e.g.: (i) on the wall surfaces of nanoscale pores; (ii) on the wall surfaces of microscale pores; (iii) submerged in the wall structure of the activated carbon matrix; and (iv) partly embedded in the wall structure of the activated carbon matrix. In situations (iii) and (iv), sulfur actually forms part of the wall structure of the pores of the sorbent body and/or sorbent material. Therefore, in certain embodiments, some of sulfur may be chemically bonded with other components of the sorbent body and/or sorbent material, such as carbon or the additive. In certain other embodiments, some of the sulfur may be physically bonded with the activated carbon matrix or other components. Still in certain other embodiments, some of the sulfur is present in the sorbent body and/or sorbent material in the form of particles having nanoscale or microscale size.

Distribution of sulfur in the sorbent body or other body or material according to the present invention can be measured and characterized by the Distribution Characterization Method described supra.

In certain embodiments, the distribution of sulfur in any target test area has the following feature: CON(max)/CON(min)≧100. In certain other embodiments: CON(max)/CON(min)≧200. In certain other embodiments: CON(max)/CON(min)≧300. In certain other embodiments: CON(max)/CON(min)≧400. In certain other embodiments: CON(max)/CON(min)≧500. In certain other embodiments: CON(max)/CON(min)≧1000. In certain other embodiments: CON(max)/CON(av)≧50. In certain other embodiments: CON(max)/CON(av)≧100. In certain other embodiments: CON(max)/CON(av)≧200. In certain other embodiments: CON(max)/CON(av)≧300. In certain other embodiments: CON(max)/CON(av)≧400. In certain other embodiments: CON(max)/CON(av)≧500. In certain other embodiments: CON(max)/CON(av)≧1000.

In certain embodiments of the Group A sorbent material and/or a precursor thereof useful for the process of the present invention, with regard to sulfur distributed in the sorbent body and/or sorbent material, the distribution thereof in all p target test areas has the following feature: CONAV(1)/CONAV(n)≧2. In certain other embodiments: CONAV(1)/CONAV(n)≧5. In certain other embodiments: CONAV(1)/CONAV(n)≧8. In certain other embodiments: CONAV(1)/CONAV(n)≧1.5. In certain other embodiments: CONAV(1)/CONAV(av)≧2. In certain other embodiments: CONAV(1)/CONAV(av)≧3. In certain other embodiments: CONAV(1)/CONAV(av)≧4. In certain other embodiments: CONAV(1)/CONAV(av)≧5. In certain other embodiments: CONAV(1)/CONAV(av)≧8. In certain other embodiments: CONAV(1)/CONAV(av)≧10.

In certain other embodiments of the Group A sorbent material and/or a precursor thereof useful for the process of the present invention, with regard to sulfur distributed in the sorbent body and/or sorbent material, in each target test area, the distribution thereof has the following feature: CON(av)/CON(min)≦30. In certain other embodiments: CON(av)/CON(min)≦20. In certain other embodiments: CON(av)/CON(min)≦15. In certain other embodiments: CON(av)/CON(min)≦10. In certain other embodiments: CON(av)/CON(min)≦5. In certain other embodiments: CON(av)/CON(min)≦3. In certain other embodiments: CON(av)/CON(min)≦2. In certain other embodiments: CON(max)/CON(av)≦30. In certain other embodiments: CON(max)/CON(av)≦20. In certain other embodiments: CON(max)/CON(av)≦15. In certain other embodiments: CON(max)/CON(av)≦10. In certain other embodiments: CON(max)/CON(av)≦5. In certain other embodiments: CON(max)/CON(av)≦3. In certain other embodiments: CON(max)/CON(av)≦2.

In certain embodiments of the Group A sorbent material and/or a precursor thereof useful for the process of the present invention, the distribution of sulfur has the following feature: in each target test area, CON(av)/CON(min)≦30, and CON(max)/CON(av)≦30. In certain other embodiments, it is desired that CON(av)/CON(min)≦20, and CON(max)/CON(av)≦20. In certain other embodiments, it is desired that CON(av)/CON(min)≦15, and CON(max)/CON(av)≦15. In certain other embodiments, it is desired that CON(av)/CON(min)≦10, and CON(max)/CON(av)≦10. In certain other embodiments, it is desired that CON(av)/CON(min)≦5, and CON(max)/CON(av)≦5. In certain other embodiments, it is desired that CON(av)/CON(min)≦3, and CON(max)/CON(av)≦3. In certain other embodiments, it is desired that CON(av)/CON(min)≦2, and CON(max)/CON(av)≦2.

In certain embodiments of the Group A sorbent material and/or a precursor thereof useful for the process of the present invention, sulfur is homogeneously distributed throughout the activated carbon matrix according to the Distribution Characterization Method described supra. Thus, in each target test area, for all CON(m) where 0.1n≦m≦0.9n: 0.5≦CON(m)/CON(av)≦2. In certain embodiments, it is desired that 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments, for all CON(m) where 0.05n≦m≦0.95n: 0.5≦CON(m)/CON(av)≦2; in certain embodiments, 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments of the Group A material and/or a precursor thereof useful for the present invention, in addition to any one of the features stated above in this paragraph with respect to each individual target test area, the distribution of the relevant material (e.g., sulfur, an additive, and the like) with respect to all p target test areas has the following feature: for all CONAV(k) where 0.1p≦k≦0.9p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05. In certain embodiments, for all CONAV(k) where 0.05p≦k≦0.95p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05.

In certain embodiments of the present invention, sulfur is present on a majority of the wall surfaces of the microscale pores of the Group A sorbent material and/or a precursor sorbent body thereof useful for the process of the presence invention. In certain other embodiments of the present invention, sulfur is present on at least 75% of the wall surfaces of the microscale pores. In certain other embodiments of the present invention, sulfur is present on at least 90% of the wall surfaces of the microscale pores. In certain other embodiments of the present invention, sulfur is present on at least 95% of the wall surfaces of the microscale pores.

In certain embodiments of the present invention, sulfur is present on at least 20% of the wall surfaces of the nanoscale pores of the Group A sorbent material and/or a precursor sorbent body thereof useful for the process of the present invention. In certain other embodiments of the present invention, sulfur is present on at least 30% of the wall surfaces of the nanoscale pores. In certain other embodiments of the present invention, sulfur is present on at least 40% of the wall surfaces of the nanoscale pores. In certain other embodiments of the present invention, sulfur is present on at least 50% of the wall surfaces of the nanoscale pores. In certain other embodiments of the present invention, sulfur is present on at least 75% of the wall surfaces of the nanoscale pores. In certain other embodiments of the present invention, sulfur is present on at least 85% of the wall surfaces of the nanoscale pores. In certain embodiments of the present invention, a majority of the specific area of the sorbent body and/or sorbent material is provided by the wall surfaces of the nanoscale pores. In these embodiments, it is desired that a high percentage (such as at least 40%, in certain embodiments at least 50%, in certain other embodiments at least 60%) of the wall surface of the nanoscale pores has sulfur distributed thereon.

In certain embodiments of the present invention, in addition to activated carbon, sulfur and the additive, the sorbent material and/or a sorbent body thereof may further comprise an inorganic filler. Such inorganic fillers may be included for the purpose of, inter alia, reducing cost, and improving physical (coefficient of thermal expansion; modulus of rupture, e.g.) or chemical properties (water resistance; high temperature resistance; corrosion-resistance, e.g.) of the sorbent body and/or sorbent material. Such inorganic filler can be an oxide glass, oxide ceramic, or certain refractory materials. Non-limiting examples of inorganic fillers that may be included in the sorbent material useful for the process of the present invention include: silica; alumina; zircon; zirconia; mullite; cordierite; refractory metals; and the like. In certain embodiments of the sorbent material useful for the process of the present invention, the inorganic fillers are per se porous. A high porosity of the inorganic fillers can improve the mechanical strength of the sorbent body and/or sorbent material without unduly sacrificing the specific area. The inorganic filler may be distributed throughout the sorbent body and/or sorbent material. The inorganic filler may be present in the form of minuscule particles distributed in the sorbent body and/or sorbent material. Depending on the application of the sorbent body and/or sorbent material and other factors, in certain embodiments, the sorbent body and/or sorbent material may comprise, e.g., up to 50% by weight of inorganic filler based on the total weight of the sorbent body and/or material, in certain other embodiments up to 40%, in certain other embodiments up to 30%, in certain other embodiments up to 20%, in certain other embodiments up to 10%.

In certain embodiments, the Group A sorbent material and/or a precursor sorbent body thereof useful for the process of the present invention comprise at least 90% by weight (in certain embodiments at least 95%, in certain other embodiments at least 98%) of activated carbon, sulfur and the additive, based on the total weight of the body or material.

It is believed that the Group A sorbent material of the present invention is capable of removing arsenic, cadmium, mercury and selenium from a typical syngas stream produced during a coal gasification process. It has been found that the Group A sorbent material useful for the process of the present invention is particularly effective in removing mercury from a flue gas stream. The removal capabilities of the Group A sorbent materials with respect to a certain toxic element, e.g., mercury, are typically characterized by two parameters: initial removal efficiency and long term removal capacity. With respect to mercury, the following procedure is to be used to characterize the initial mercury removal efficiency and long term mercury removal capacity:

The sorbent body and/or sorbent material to be tested is loaded into a fixed bed through which a reference flue gas at 160° C. having a specific composition is passed at a space velocity of 7500 hr⁻¹. Concentrations of mercury in the gas stream are measured before and after the sorbent bed. At any given time, the instant mercury removal efficiency (Eff(Hg)) is calculated as follows:

$$Eff ( Hg ) = \frac{{C}_{0} - {C}_{1}}{{C}_{0}} \times 100 \% ,$$

where C₀ is the total mercury concentration in μg·m⁻³ in the flue gas stream immediately before the sorbent bed, and C₁ is the total mercury concentration in μg·m⁻³ immediately after the sorbent bed. Initial mercury removal efficiency is defined as the average mercury removal efficiency during the first 1 (one) hour of test after the fresh test sorbent material is loaded. Typically, the mercury removal efficiency of a fixed sorbent bed diminishes over time as the sorbent bed is loaded with more and more mercury. Mercury removal capacity is defined as the total amount of mercury trapped by the sorbent bed per unit mass of the sorbent material until the instant mercury removal efficiency diminishes to 90% under the above testing conditions. Mercury removal capacity is typically expressed in terms of mg of mercury trapped per gram of sorbent material (mg·g⁻¹).

An exemplary test reference flue gas (referenced as RFG1 herein) has the following composition by volume: O₂ 5%; CO₂ 14%; SO₂ 1500 ppm; NOx 300 ppm; HCl 100 ppm; Hg 20-25 μg·m⁻³; N₂ balance; wherein NOₓ is a combination of NO₂, N₂O and NO; Hg is a combination of elemental mercury (Hg(0), 50-60% by mole) and oxidized mercury (40-50% by mole).

In certain embodiments of the present invention, the Group A sorbent material useful for the process of the present invention has an initial mercury removal efficiency with respect to RFG1 of at least 91%, in certain embodiments at least 92%, in certain other embodiments at least 95%, in certain other embodiments at least 97%, in certain other embodiments at least 98%, in certain other embodiments at least 99%, in certain other embodiments at least 99.5%.

In certain embodiments of the present invention, the Group A sorbent material advantageously has a high initial mercury removal efficiency of at least 91% for flue gases comprising O₂ 5%; CO₂ 14%; SO₂ 1500 ppm; NOₓ 300 ppm; Hg 20-25 μg·m⁻³, having high concentrations of HCl and low concentrations of HCl alike. By “high concentrations of HCl” is meant that HCl concentration in the gas to be treated is at least 20 ppm. By “low concentration of HCl” is meant that HCl concentration in the gas to be treated is at most 10 ppm. The sorbent body and/or sorbent material of certain embodiments of the present invention advantageously has a high initial mercury removal efficiency of at least 91% (in certain embodiments at least 95%, in certain other embodiments at least 98%, in certain other embodiments at least 99.0%, in certain other embodiments at least 99.5%) for a flue gas (referred to as RFG2) having the following composition: O₂ 5%; CO₂ 14%; SO₂ 1500 ppm; NOₓ 300 ppm; HCl 5 ppm; Hg 20-25 μg·m⁻³; N₂ balance. High mercury removal efficiency of these embodiments of the Group A sorbent material of the present invention for low HCl flue gas is particularly advantageous compared to the prior art. In the prior art processes involving the injection of conventional activated carbon powder, it is typically required that HCl be added to the flue gas in order to obtain a decent initial mercury removal efficiency. The embodiments of the present invention presenting high mercury efficiency at low HCl concentration allows for the efficient and effective removal of mercury from a flue gas stream without the need of injecting HCl into the gas stream.

In certain embodiments of the present invention, the Group A sorbent material advantageously has a high initial mercury removal efficiency of at least 91% for flue gases comprising O₂ 5%; CO₂ 14%; SO₂ 1500 ppm; NOₓ 300 ppm; Hg 20-25 μg·m⁻³, having high concentrations of SO₃ (such as 5 ppm, 8 ppm, 10 ppm, 15 ppm, 20 ppm, 30 ppm) and low concentrations of SO₃ alike (such as 0.01 ppm, 0.1 ppm, 0.5 ppm, 1 ppm, 2 ppm). By “high concentrations of SO₃” is meant that SO₃ concentration in the gas to be treated is at least 3 ppm by volume. By “low concentration of SO₃” is meant that SO₃ concentration in the gas to be treated is less than 3 ppm. The sorbent body and/or sorbent material of certain embodiments of the present invention advantageously has a high initial mercury removal efficiency of at least 91% (in certain embodiments at least 93%, in certain embodiments at least 95%, in certain embodiments at least 96%, in certain embodiments at least 98%, in certain embodiments at least 99%, in certain other embodiments at least 99.5%) for a flue gas (referred to as RFG3) having the following composition: O₂ 5%; CO₂ 14%; SO₂ 1500 ppm; NOₓ 300 ppm; SO₃ 5 ppm; Hg 20-25 μg·m⁻³; N₂ balance. High mercury removal efficiency of certain embodiments of the Group A sorbent material and/or a precursor body thereof useful for the process of the present invention for high SO₃ flue gas is particularly advantageous compared to the prior art. In the prior art processes involving the injection of conventional activated carbon powder, it is typically required that SO₃ be removed from the flue gas in order to obtain a decent initial mercury removal efficiency. The embodiments of the present invention presenting high mercury efficiency at high SO₃ concentration allows for the efficient and effective removal of mercury from a flue gas stream without the need of prior removal of SO₃ from the gas stream.

Moreover, in certain embodiments of the present invention, the Group A sorbent material advantageously has a high mercury removal capacity with respect to RFG1 of at least 0.10 mg·g⁻¹, in certain embodiments at least 0.20 mg·g⁻¹, in certain embodiments at least 0.25 mg·g⁻¹, in certain embodiments at least 0.30 mg·g⁻¹.

Moreover, in certain embodiments of the present invention, the Group A sorbent material advantageously has a high mercury removal capacity with respect to RFG2 of at least 0.10 mg·g⁻¹, in certain other embodiments at least 0.20 mg·g⁻¹, in certain other embodiments at least 0.25 mg·g⁻¹, in certain other embodiments at least 0.30 mg·g⁻¹. Thus, the sorbent bodies according to these embodiments have a high mercury removal capacity with respect to low HCl flue gas streams. This is particularly advantageous compared to prior art mercury abatement processes.

Moreover, in certain embodiments of the present invention, the Group A sorbent material advantageously has a high mercury removal capacity of at least 0.20 mg·g⁻¹, in certain embodiments at least 0.25 mg·g⁻¹, in certain embodiments at least 0.30 mg·g⁻¹, with respect to RFG3. Thus, the sorbent bodies according to these embodiments have a high mercury removal capacity with respect to high SO₃ flue gas streams. This is particularly advantageous compared to the prior art mercury abatement processes.

Due to the removal ability of elemental mercury from the fluid stream of the sorbent body and/or sorbent material, a particularly advantageous embodiment of the process comprises placing the sorbent body and/or sorbent material in a gas stream comprising mercury wherein at least 10% by mole of the mercury atoms are in elemental state. In certain embodiments, at least 20% of the mercury atoms contained in the gas stream are in elemental state, in certain other embodiments at least 30%, in certain other embodiments at least 40%, in certain other embodiments at least 50%, in certain other embodiments at least 60%, in certain other embodiments at least 70%.

Due to the removal ability of mercury from the fluid stream of the sorbent body and/or sorbent material of certain embodiments of the present invention, even if the gas stream comprises HCl at a very low level, a particularly advantageous embodiment of the process comprises placing the sorbent body and/or sorbent material in a gas stream comprising mercury and HCl at a HCl concentration of lower than 50 ppm by volume, in certain embodiments lower than 40 ppm, in certain other embodiments lower than 30 ppm, in certain other embodiments lower than 20 ppm, in certain other embodiments lower than 10 ppm.

Due to the removal ability of mercury from the fluid stream of the sorbent body and/or sorbent material, even if the gas stream comprises SO₃ at a high level, a particularly advantageous embodiment of the process comprises placing the sorbent body and/or sorbent material in a gas stream comprising mercury and SO₃ at a SO₃ concentration higher than 3 ppm by volume, in certain embodiments higher than 5 ppm, in certain other embodiments higher than 8 ppm, in certain other embodiments higher than 10 ppm, in certain other embodiments higher than 20 ppm.

A precursor body of the Group A sorbent material useful for the present invention can be made by a process comprising the following steps:

(A) providing a batch mixture body formed of a batch mixture material comprising a carbon-source material, a sulfur-source material, an additive-source material and an optional filler material, wherein the additive-source material is substantially homogeneously distributed in the batch mixture material;

(B) carbonizing the batch mixture body by subjecting the batch mixture body to an elevated carbonizing temperature in an O₂-depleted atmosphere to obtain a carbonized batch mixture body;

(C) activating the carbonized batch mixture body at an elevated activating temperature in a CO₂ and/or H₂O-containing atmosphere.

In certain embodiments, the carbon-source material comprises: synthetic carbon-containing polymeric material; activated carbon powder; charcoal powder; coal tar pitch; petroleum pitch; wood flour; cellulose and derivatives thereof; wheat flour; nut-shell flour; starch; coke; coal; or mixtures or combinations of any two or more of these. All these materials contain certain components comprising carbon atoms in its structure units on a molecular level that can be at least partly retained in the final activated carbon matrix of the sorbent material useful for the process of the present invention.

In one embodiment, the synthetic polymeric material can be a synthetic resin in the form of a solution or low viscosity liquid at ambient temperatures. Alternatively, the synthetic polymeric material can be a solid at ambient temperature and capable of being liquefied by heating or other means. Examples of useful polymeric carbon-source materials include thermosetting resins and thermoplastic resins (e.g., polyvinylidene chloride, polyvinyl chloride, polyvinyl alcohol, and the like). Still further, in one embodiment, relatively low viscosity carbon precursors (e.g., thermosetting resins) can be preferred, having exemplary viscosity ranges from about 50 to 100 cps. In another embodiment, any high carbon yield resin can be used. To this end, by high carbon yield is meant that greater than about 10% of the starting weight of the resin is converted to carbon on carbonization. In another embodiment, the synthetic polymeric material can comprise a phenolic resin or a furfural alcohol based resin such as furan resins. Phenolic resins can again be preferred due to their low viscosity, high carbon yield, high degree of cross-linking upon curing relative to other precursors, and low cost. Exemplary suitable phenolic resins are resole resin such as plyophen resin. An exemplary suitable furan liquid resin is Furcab-LP from QO Chemicals Inc., IN, U.S.A. An exemplary solid resin well suited for use as a synthetic carbon precursor in the present invention is solid phenolic resin or novolak. Still further, it should be understood that mixtures of novolak and one or more resole resins can also be used as suitable polymeric carbon-source material. The phenolic resin may be pre-cured or uncured when mixed with other material to form the batch mixture material. Where the phenolic resin is pre-cured, the pre-cured material may comprise sulfur, additive or the optional inorganic filler pre-loaded. As indicated infra, in certain embodiments, it is desired that a curable, uncured resin is included as part of the carbon-source material in the batch mixture material. Curable materials, thermoplastic or thermosetting, undergo certain reactions, such as chain propagation, crosslinking, and the like, to form a cured material with higher degree of polymerization when being subjected to cure conditions, such as mild heat treatment, irradiation, chemical activation, and the like.

In certain embodiments, organic binders typically used in extrusion processes can be part of the carbon-source material as well. Exemplary binders that can be used are plasticizing organic binders such as cellulose ethers. Typical cellulose ethers include methylcellulose, ethylhydroxy ethylcellulose, hydroxybutyl-cellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. Further, methylcellulose and/or methylcellulose derivatives are especially suited as organic binders in the practice of the present invention, with methylcellulose, hydroxypropyl methylcellulose, or combinations of these being preferred.

Carbonizable organic fillers may be used as part of the carbon-source material in certain embodiments of the process of the present invention. Exemplary carbonizable fillers include both natural and synthetic, hydrophobic and hydrophilic, fibrous and non-fibrous fillers. For example some natural fillers are soft woods, e.g., pine, spruce, redwood, etc.; hardwoods, e.g., ash, beech, birch, maple, oak, etc.; sawdust, shell fibers, e.g., ground almond shell, coconut shell, apricot pit shell, peanut shell, pecan shell, walnut shell, etc.; cotton fibers, e.g., cotton flock, cotton fabric, cellulose fibers, cotton seed fiber; chopped vegetable fibers, for example, hemp, coconut fiber, jute, sisal, and other materials such as corn cobs, citrus pulp (dried), soybean meal, peat moss, wheat flour, wool fibers, corn, potato, rice, tapiocas, etc. Some synthetic materials are regenerated cellulose, rayon fabric, cellophane, etc. One especially suited carbonizable fiber filler is cellulose fiber as supplied by International Filler Corporation, North Tonawanda, N.Y. This material has the following sieve analysis: 1-2% on 40 mesh (420 micrometers), 90-95% thru 100 mesh (149 micrometers), and 55-60% thru 200 mesh (74 micrometers). Some hydrophobic organic synthetic fillers are polyacrylonitrile fibers, polyester fibers (flock), nylon fibers, polypropylene fibers (flock) or powder, acrylic fibers or powder, aramid fibers, polyvinyl alcohol, etc. Such organic fiberous fillers may function in part as part of the carbon-source material, in part as mechanical property enhancer to the batch mixture body, and in part as fugitive pore formers that would mostly vaporize upon carbonization.

Non-limiting examples of additive-source material include: alkali and alkaline earth halides, oxides and hydroxides; oxides, sulfides, and salts of vanadium, chromium, manganese, iron, cobalt, nickel, copper, zinc, niobium, molybdenum, silver, tungsten, and lanthanoids. The metallic elements in the additive-source materials can be at various valencies. For example, if iron is included in the additive-source material, it may be present at +3, +2 or 0 valencies or as mixtures of differing valencies, and can be present as metallic iron (0), FeO, Fe₂O₃, Fe₃O₈, FeS, FeCl₂, FeCl₃, FeSO₄, and the like. For another example, if manganese is present in the additive, it may be present at +4, +2 or 0 valencies or mixtures of differing valences, and can be present as metallic manganese (0), MnO, MnO₂, MnS, MnCl₂, MnCl₄, MnSO₄, and the like.

Non-limiting examples of sulfur-source material include: sulfur powder; sulfur-containing powdered resin; sulfides; sulfates; and other sulfur-containing compounds; or mixtures or combination of any two or more of these. Exemplary sulfur-containing compounds can include hydrogen sulfide and/or its salts, carbon disulfide, sulfur dioxide, thiophene, sulfur anhydride, sulfur halides, sulfuric ester, sulfurous acid, sulfacid, sulfatol, sulfamic acid, sulfan, sulfanes, sulfuric acid and its salts, sulfite, sulfoacid, sulfobenzide, and mixtures thereof. When elemental sulfur powder is used, in one embodiment it can be preferred to have an average particle diameter that does not exceed about 100 micrometers. Still further, it is preferred in certain embodiments that the elemental sulfur powder has an average particle diameter that does not exceed about 10 micrometers.

Inorganic fillers are not required to be present in the batch mixture material. However, if present, the filler material can be, e.g.: oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, etc. Some examples of especially suited inorganic fillers are cordierite powder, talcs, clays, and aluminosilicate fibers such as provided by Carborundum Co. Niagara Falls, N.Y. under the name of Fiberfax, and combinations of these. Fiberfax aluminosilicate fibers measure about 2-6 micrometers in diameter and about 20-50 micrometers in length. Additional examples of inorganic fillers are various carbides, such as silicon carbide, titanium carbide, aluminum carbide, zirconium carbide, boron carbide, and aluminum titanium carbide; carbonates or carbonate-bearing minerals such as baking soda, nahcolite, calcite, hanksite and liottite; and nitrides such as silicon nitride.

The batch mixture material may further comprise other components, such as forming aids, fugitive fillers (filler materials that would typically be eliminated during the subsequent carbonization and/or activation steps to leave voids in the shaped body), and the like. To this end, exemplary forming aids can include soaps, fatty acids, such as oleic, linoleic acid, etc., polyoxyethylene stearate, etc. or combinations thereof. In one embodiment, sodium stearate is a preferred forming aid. Optimized amounts of the optional extrusion aid(s) will depend on the composition and binder. Other additives that are useful for improving the extrusion and curing characteristics of the batch are phosphoric acid and oil. Phosphoric acid improves the cure rate and increases adsorption capacity. If included, it is typically about 0.1% to 5 wt % in the batch mixture material. Still further, an oil addition can aid in extrusion and can result in increases in surface area and porosity. To this end, an optional oil can be added in an amount in the range from about 0.1 to 5 wt. % of the batch mixture material. Exemplary oils that can be used include petroleum oils with molecular weights from about 250 to 1000, containing paraffinic and/or aromatic and/or alicyclic compounds. So called paraffinic oils composed primarily of paraffinic and alicyclic structures are preferred. These can contain additives such as rust inhibitors or oxidation inhibitors such as are commonly present in commercially available oils. Some useful oils are 3 in 1 oil from 3M Co., or 3 in 1 household oil from Reckitt and Coleman Inc., Wayne, N.J. Other useful oils can include synthetic oils based on poly(alpha olefins), esters, polyalkylene glycols, polybutenes, silicones, polyphenyl ether, CTFE oils, and other commercially available oils. Vegetable oils such as sunflower oil, sesame oil, peanut oil, etc. are also useful. Especially suited are oils having a viscosity of about 10 to 300 cps, and preferably about 10 to 150 cps.

In order to obtain a desired pore structure in the final sorbent material, an optional pore-forming agent can be incorporated into the batch mixture material. In one embodiment, exemplary pore forming agents can include polypropylene, polyester or acrylic powders or fibers that decompose in inert atmosphere at high temperature (>400° C.) to leave little or no residue. Additional pore formers include natural and synthetic starches. In some cases, such as when a starch is used as a pore former for example, the water soluble pore former may be removed after curing the honeycombs via water dissolution before carbonization process. Alternatively, in another embodiment, a suitable pore former can form macropores due to particle expansion. For example, intercalated graphite, which contains an acid such as hydrochloric acid, sulfuric acid or nitric acid, will form macropores when heated, due to the resulting expansion of the acid. Still further, macropores can also be formed by dissolving certain fugitive materials. For example, baking soda, calcium carbonate or limestone particles having a particle size corresponding to desired pore size can be extruded with carbonaceous materials to form monolithic sorbents. Baking soda, calcium carbonate or limestone forms water soluble oxides during the carbonization and activation processes, which can subsequently be leached to form macropores by soaking the monolithic sorbent in water.

In order to obtain a distribution of an additive throughout the final sorbent body and/or sorbent material, it is highly desired that the carbon-source materials and the additive-source materials are intimately mixed to form the batch mixture material. To that end, it is desired in certain embodiments that the various source materials are provided in the form of fine powders, or solutions if possible, and then mixed intimately by using an effective mixing equipment. When powders are used, they are provided in certain embodiments with average size not larger than 100 μm, in certain other embodiments not larger than 10 μm, in certain other embodiments not larger than 1 μm.

Various equipment and process may be used to form the batch mixture material into the desired shape of the batch mixture body. For example, extrusion, casting, pressing, and the like, may be used for shaping the batch mixture body. Of these, extrusion is especially preferred in certain embodiments. Extrusion can be done by using standard extruders (single-screw, double-screw, and the like) and custom extrusion dies, to make sorbent bodies with various shapes and geometries, such as honeycombs, pellets, rods, spaghetti, and the like. Extrusion is particularly effective for making monolithic honeycomb bodies having a plurality of empty channels that can serve as fluid passageways. Extrusion is advantageous in that it can achieve a highly intimate mixing of all the source materials as well during the extrusion process.

In certain embodiments, it is desired that the batch mixture material comprises an uncured curable material. In those embodiments, upon forming of the batch mixture body, the sorbent body and/or sorbent material is typically subjected to a curing condition, e.g., heat treatment, such that the curable component cures, and a cured batch mixture body forms as a result. The cured batch mixture body tends to have better mechanical properties than its non-cured predecessor, and thus handles better in down-stream processing steps. Moreover, without the intention or necessity to be bound by any particular theory, it is believed that the curing step can result in a polymer network having a carbon backbone, which can be conducive to the formation of carbon network during the subsequent carbonization and activation steps. In certain embodiments the curing is generally performed in air at atmospheric pressures and typically by heating the formed batch mixture body at a temperature of about 100° C. to about 200° C. for about 0.5 to about 5.0 hours. Alternatively, when using certain precursors, (e.g., furfuryl alcohol) curing can also be accomplished by adding a curing additive such as an acid additive at room temperature. The curing can, in one embodiment, serve to retain the uniformity of the toxic metal adsorbing additive distribution in the carbon.

After formation of the batch mixture body, drying thereof, or optional curing thereof, the shaped body is subjected to a carbonization step, wherein the batch mixture body (cured or uncured) is heated to an elevated carbonizing temperature in an O₂-depleted atmosphere. The carbonization temperature can range from 600 to 1200° C., in certain embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the batch mixture body decompose to leave a carbonaceous residue. As can be expected, complex chemical reactions take place in this high-temperature step. Such reactions can include, inter alia:

(i) decomposition of the carbon-source materials to leave a carbonaceous body;

(ii) decomposition of the additive-source materials;

(iii) decomposition of the sulfur-source materials;

(iv) reactions between the sulfur-source materials and the carbon-source materials;

(v) reactions between the sulfur-source materials and carbon;

(vi) reactions between the sulfur-source materials and additive-source materials;

(vii) reactions between the additive-source materials and carbon-source materials; and

(viii) reactions between the additive-source materials and carbon.

The net effect can include, inter alia: (1) re-distribution of the additive-source material and/or the additive; (2) re-distribution of sulfur; (3) formation of elemental sulfur from the sulfur-source material (such as sulfates, sulfites, and the like); (4) formation of sulfur-containing compounds from the sulfur-source material (such as elemental sulfur); (5) formation of additive in oxide form; (6) formation of additive in sulfide form; (7) reduction of part of the additive-source materials. Part of the sulfur (especially those in elemental state), and part of the additive-source material (such as KI) may be swept away by the carbonization atmosphere during carbonization.

The result of the carbonization step is a carbonaceous body with sulfur and additive distributed therein. However, this carbonized batch mixture body typically does not have the desired specific surface area for an effective sorption of toxic elements. To obtain the final sorbent body and/or sorbent material with a high specific surface area, the carbonized batch mixture body is further activated at an elevated activating temperature in a CO₂ and/or H₂O-containing atmosphere. The activating temperature can range from 600° C. to 1000° C., in certain embodiments from 600° C. to 900° C. During this step, part of the carbonaceous structure of the carbonized batch mixture body is mildly oxidized:

CO₂(g)+C(s)→2CO(g),

H₂O(g)+C(s)→H₂(g)+CO(g),

resulting in the etching of the structure of the carbonaceous body and formation of an activated carbon matrix defining a plurality of pores on nanoscale and microscale. The activating conditions (time, temperature and atmosphere) can be adjusted to produce the final product with the desired specific area and composition. Similar to the carbonizing step, due to the high temperature of this activating step, complex chemical reactions and physical changes occur. It is highly desired that at the end of the activation step, the additive is distributed throughout the activated carbon matrix. It is highly desired that at the end of the activation step, the additive is distributed substantially homogeneously throughout the activated carbon matrix. It is highly desired that at the end of the activation step, the additive is present on at least 30%, in certain embodiments at least 40%, in certain other embodiments at least 50%, in certain other embodiments at least 60%, in certain other embodiments at least 80%, of the wall surface area of the pores. It is highly desired that at the end of the activation step, sulfur is distributed throughout the activated carbon matrix. It is highly desired that at the end of the activation step, sulfur is distributed substantially homogeneously throughout the activated carbon matrix. It is highly desired that at the end of the activation step, sulfur is present on at least 30%, in certain embodiments at least 40%, in certain other embodiments at least 50%, in certain other embodiments at least 60%, in certain other embodiments at least 80%, of the wall surface area of the pores.

In certain embodiments, all additive-source materials and all sulfur-source materials are included into the batch mixture body by in-situ forming, such as in-situ extrusion, casting, and the like. This process has the advantages of, inter alia: (a) avoiding a subsequent step (such as impregnation) of loading an additive and/or sulfur onto the activated carbon body, thus potentially reducing process steps, increasing overall process yield, and reducing process costs; (b) obtaining a more homogeneous distribution of active sorption sites (additives and sulfur) in the sorbent body and/or sorbent material than what is typically obtainable by impregnation; and (c) obtaining a durable and robust fixation of the additive and sulfur in the sorbent body and/or sorbent material, which can withstand the flow of the fluid stream to be treated for a long service period. Impregnation can result in preferential distribution of impregnated species (such as additive and sulfur) on external cell walls, wall surface of large pores (such as those on the micrometer scale). Loading of impregnated species onto a high percentage of the wall surfaces of the nanoscale pores can be time-consuming and difficult. Most of the surface area of activated carbon having high specific area of from 400 to 2000 m²·g⁻¹ are contributed by the nanoscale pores. Thus, it is believed that it is difficult for a typical impregnation step to result in loading of the impregnated species onto a majority of the specific area of such activated carbon material. Moreover, it is believed that a typical impregnation step can result in a thick, relatively dense layer of the impregnated species on the external cell walls and/or wall surface of large pores, which blocks the fluid passageways into or out of the smaller pores, effectively reducing the sorptive function of the activated carbon. Still further, it is believed that the fixation of the impregnated species in a typical impregnation step in the sorbent body and/or sorbent material is mainly by relatively weak physical force, which may be insufficient for prolonged use in fluid streams.

Nonetheless, as indicated supra, in certain embodiments, it is not necessary that all the additives and/or sulfur are required to be distributed throughout the activated carbon matrix, let alone substantially homogeneously. In these embodiments, not all of the additive-source materials and sulfur-source materials are formed in situ into the batch mixture body. It is contemplated that, after the activation step, a step of impregnation of certain additives and/or sulfur may be carried out. Alternatively, after the activated step, a step of treating the activated body by a sulfur-containing and/or additive-containing atmosphere may be carried out. Such post-activation loading of additive is especially useful for additives that cannot withstand the carbonization and/or carbonization steps, such as those based on organometallic compounds, e.g., iron acetylacetonate.

Once the activated sorbent material useful for the process of the present invention is formed, it may be subjected to post-finishing steps, such as pellitizing, grinding, assembling by stacking, and the like. Sorbent bodies of various shapes and compositions of the present invention may then be loaded into a fixed bed which will be placed into the fluid stream to be treated.

As mentioned supra, the Group A particles can be formed by pulverizing the Group A precursor bodies formed by any method, such as those described supra.

Alternatively, the Group A particles can be formed by a process comprising the following steps:

(a) providing a plurality of batch-mixture particles comprising a carbon-source material such as those described supra, a sulfur-source material such as described supra, an additive-source material such as described supra and an optional filler material such as described above, wherein the additive-source material is substantially homogeneously distributed in the particles;

(b) carbonizing the batch mixture particles by subjecting the batch mixture particle to an elevated carbonizing temperature in an O₂-depleted atmosphere to obtain a carbonized batch mixture body; and

(c) activating the carbonized batch mixture particles at an elevated activating temperature in a CO₂ and/or H₂O-containing atmosphere.

The carbonized batch mixture particles can be used as they are, or may be further pulverized before being used as Group A particles.

In one embodiment, in step (a), the batch mixture particles are formed by flow drying a mixture comprising a carbon-containing resin, a sulfur-source material and an additive-source material. The thus flow-dried particles are then carbonized and activated in the subsequent steps to obtain the Group A particles or precursor bodies thereof.

The present invention is further illustrated by the following non-limiting examples of sorbent materials and sorbent bodies and processes for making them.

### EXAMPLES

### Example 1

An extrusion composition was formulated with 46% liquid phenolic resole resin, 1% lubricating oil, 13% cordierite powder, 9% sulfur powder, 7% iron acetylacetonate, 18% cellulose fiber, 5% Methocel binder and 1% sodium stearate. This mixture was compounded and then extruded. The extruded honeycomb was then dried and cured in air at 150° C. followed by carbonization in nitrogen and activation in carbon dioxide. The activated carbon honeycomb samples were then tested for the mercury removal capability. The test was done at 160° C. with 22 μg·m⁻³ inlet elemental mercury concentration. The carrier gas for mercury contained N₂, SO₂, O₂ and CO₂. The gas flow rate was 750 ml/minute. The total mercury removal efficiency was 86% while elemental mercury removal efficiency was 100%.

### Example 2

Another extrusion composition was extruded similar to Example 1 but with 12% cordierite powder instead of 13% and the iron acetylacetonate at 4% and potassium iodide at 4% instead of 7% iron acetylacetonate. After activation these samples showed 90% total mercury removal and 100% elemental mercury removal. The presence of KI in the composition thus increased the efficiency.

### Example 3

In this experiment the extrusion composition was 59% phenolic resole, 1% phosphoric acid, 1% oil, 9% sulfur powder, 3% iron oxide, 19% cellulose fiber, 7% methocel binder and 1% sodium stearate. These samples were extruded, cured carbonized, activated and tested as in Example 1 for mercury removal performance. The mercury removal efficiency was 87% and 97% for total and elemental mercury, respectively.

### Example 4

In this experiment manganese oxide was used as the additives with the composition of 6% MnO₂, 13% cordierite, 7% sulfur, 19% cellulose fiber, 5% methocel binder, 1% sodium stearate, 47% phenolic resole, 1% phosphoric acid and 1% oil. The mercury removal efficiency of the samples based on this composition was 92% and 98% for total and elemental mercury, respectively.

### Example 5

In this example sulfur was added combined with manganese as MnS instead of elemental sulfur. The composition was 15% cordierite, 10% MnS, 20% cellulose fiber, 5% methocel binder, 1% sodium stearate, 47% phenolic resole, and 1% oil.

On cure, carbonization and activation the mercury removal efficiency of these honeycombs was 84% and 93% for total and elemental mercury.

### Example 6

The experiment of Example 5 was repeated but with molybdenum disulfide (MoS₂) as the additive. These samples gave mercury removal efficiency of 90% and 96% for total and elemental mercury.

These Examples show that various combinations of additives when incorporated as in-situ catalysts in the extrusion compositions lead to activated carbon honeycombs with high mercury removal efficiencies.

It is expected that these honeycombs will also be useful for removal of other contaminants such as selenium, cadmium and other toxic metals from flue gases as well as in coal gasification.

### Example 7

In this experiment the extrusion composition was 14% charcoal, 47% phenol resin, 7% sulfur, 7% manganese oxide, 18% cellulose fiber, 5% mythical binder and 1% sodium separate. These samples were extruded, cured, carbonized and activated as in Example 1.

The samples were then tested for mercury removal capability. The test was done at 140° C. with 24 μg/m³ inlet elemental mercury concentration. The carrier gas for mercury contained N₂, HCl, SO₂, NO_{R}, O₂ and CO₂ The gas flow rate was 650 ml/minute. The mercury removal efficiency was 100% and 99% for both total and elemental mercury, respectively. See TABLE II below.

### Example 8

In this example, the extrusion composition was 16% cured sulfur-containing phenol resin, 45% phenol resin, 8% sulfur, 7% manganese oxide, 18% cellulose fiber, 4% mythical binder and 1% sodium separate. These samples were extruded, cured, carbonized and activated as in Example 1. The activated carbon samples were tested as in Example 7. The mercury removal efficiency was 100% and 99% for both total and elemental mercury, respectively. See TABLE II below. Thus both Examples 7 and 8 achieved excellent mercury removal results.

Various sorbent bodies comprising differing additives were tested for mercury removal efficiency. Test results are listed in TABLE I below. In all tables and drawings in the present application, Hg⁰ or Hg(0) means elemental mercury; Hg^{T} or Hg(T) means total mercury, including elemental and oxidized mercury. Eff(Hg(0) or Eff(Hg(0)) means the instant mercury removal efficiency with respect to elemental mercury, and Eff(Hg^{T}) or Eff(Hg(T)) means instant mercury removal efficiency with respect to mercury at all oxidation states. Just as described above, Eff(Hg(x)) is calculated as follows:

$$Eff ( Hg ( x ) ) = \frac{{C}_{0} - {C}_{1}}{{C}_{0}} \times 100 \% ,$$

where C₀ is the inlet concentration of Hg(x), and C₁ is the outlet concentration of Hg(x), respectively, at a given test time.

Comparison of Sample Nos. C and D in TABLE I clearly shows that a Group A sorbent material comprising MnS as an additive tends have higher performance if it also comprises elemental sulfur in the batch mixture material than if it does not comprise elemental sulfur in the batch mixture material.

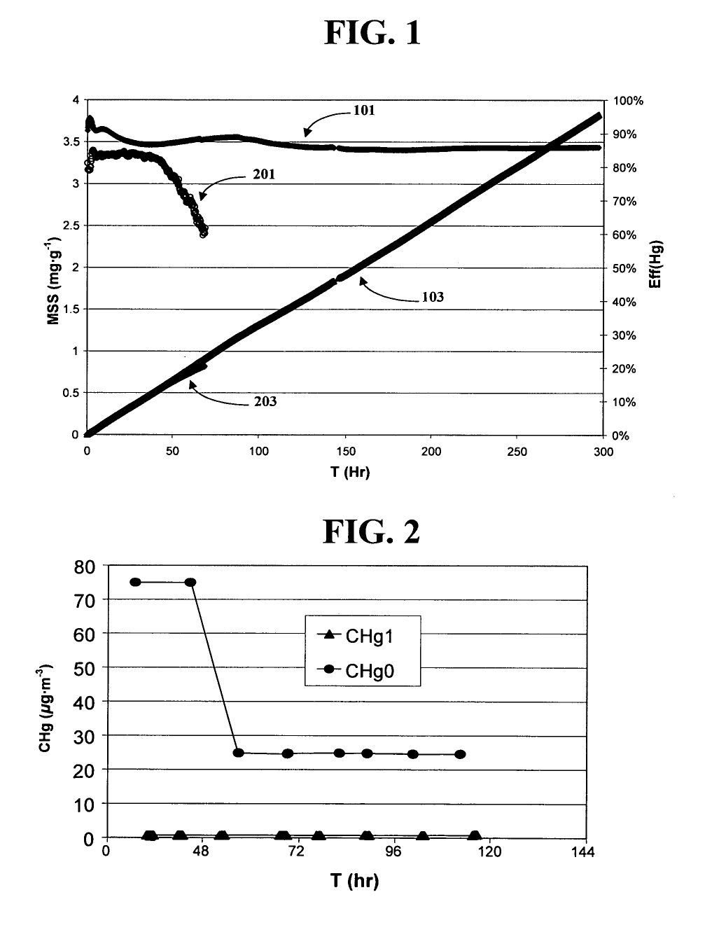

FIG. 1 is a diagram comparing the mercury removal capability of a tested sample of a sorbent according to the present invention and a comparative sorbent over time. On the left vertical axis is the aggregate amount of mercury per unit mass (MSS, mg·g⁻¹) trapped by the tested samples of the tested sorbents. On the right vertical axis is instant mercury removal efficiency of the tested sorbents (Eff(Hg)), which is the instant total mercury removal efficiency measured and calculated according to the formula above. On the horizontal axis is the time the sample was exposed to the test gas. Part of the Eff(Hg) data in this figure are also presented in TABLE III below. The sorbent according to the present invention comprises sulfur, in-situ extruded MnO₂ as the additive and about 45% by weight of cordierite as an inorganic filler. Sample 2.2 is a comparative sorbent comprising no in-situ extruded additive, comparable amount of sulfur and cordierite, and impregnated FeSO₄ and KI as the additive. Curves 101 and 103 show the Eff(Hg) and MSS of the sorbent according to the present invention, respectively. Curves 201 and 203 show the Eff(Hg) and MSS of the comparative sorbent, respectively. As can be seen from this figure and the data of TABLE III, the sorbent did not show an abrupt drop of mercury removal efficiency even after 250 hours of exposure to a simulated flue gas comprising total mercury at about 20 μg·m⁻³, indicating a fairly large amount of mercury can be trapped by the Group A sorbent material before it reaches saturation (or mercury break-through point). The curve 201 and data of TABLE III show that the comparative sorbent had an abrupt, continuous drop of instant mercury removal efficiency within 50 hours until about 70 hours when the test was terminated, indicating an early saturation of the sorbent. Curves 103 and 203 overlap to a certain extent at the early stage of test period, but 203 ends at about 69 hours.

FIG. 1 shows that the sorbent of this embodiment, comprising in-situ extruded additive, can have much higher mercury removal capability, especially on the long term, than sorbent having impregnated additives. Without the intention or necessity to be bound by a particular theory, it is believed that the superior performance of the sorbent of the present invention is due to the more homogeneous distribution of the additive, and less blockage of the pores in the activated carbon matrix by the additives.

FIG. 2 is a diagram showing the inlet mercury concentration (CHg0) and outlet mercury concentration (CHg1) of sorbent bodies according to one embodiment of the present invention various inlet mercury concentrations. This diagram clearly indicates that the sorbent bodies of certain embodiments of the present invention can be used to remove mercury effectively at various mercury concentration (ranging from above 70 to about 25 μg·m⁻³).

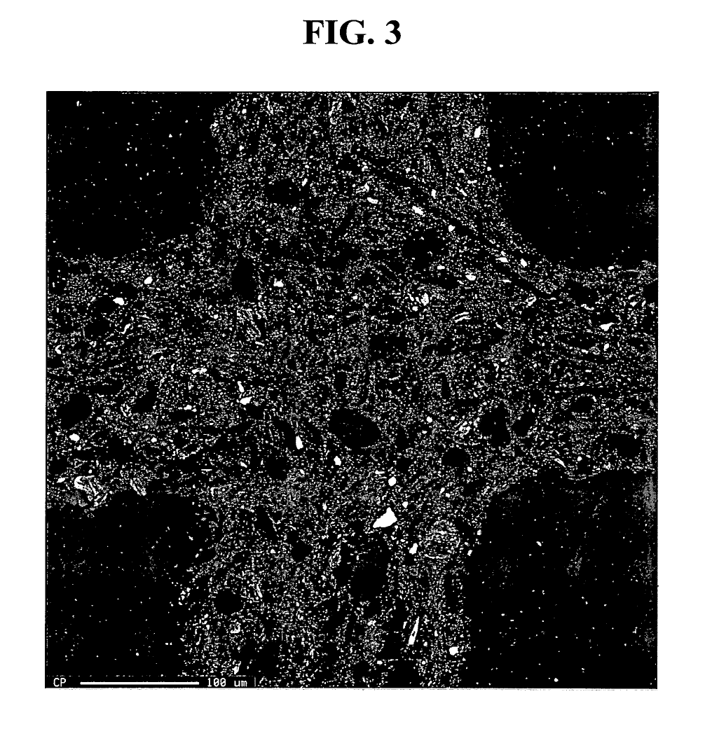

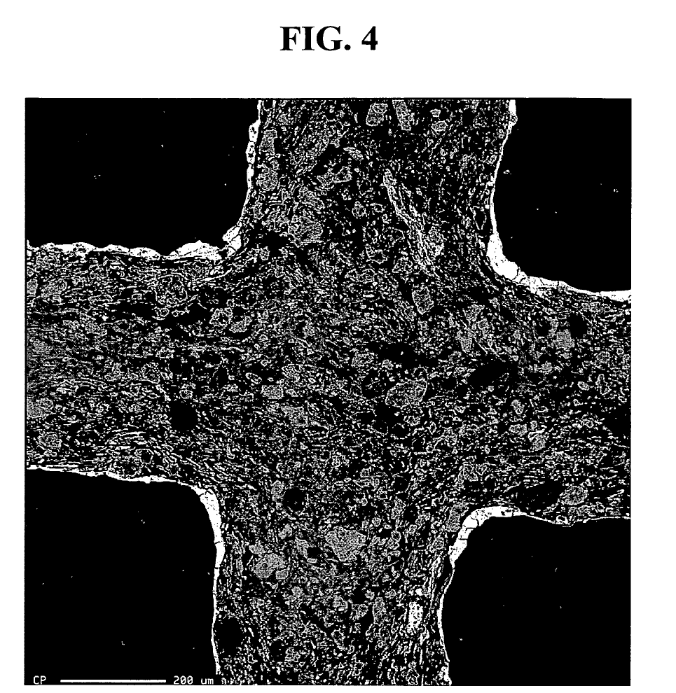

FIG. 3 is a SEM image of part of a cross-section of a sorbent body according to the present invention comprising in-situ extruded additive. From the image, preferential accumulation of additive or sulfur is not observed. FIG. 4 is a SEM image of part of a cross-section of a comparative sorbent body comprising post-activation impregnated additive. The clearly visible white layer of material on the cell wall is the impregnated additive. It is believed that this relatively dense layer of impregnated layer of additive can block the entrances into many macroscale and nanoscale pores inside the cell walls, reducing the overall performance of the comparative sorbent body.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

TABLE I

| | | Test | Hg^{T} Inlet | Eff | Eff |
|---|---|---|---|---|---|
| Sample | | Time | Concentration | (Hg⁰) | (Hg^{T}) |
| No. | Additive-Source | (Hours) | (μg · m⁻³) | (%) | (%) |
| A | MnO₂ | 20 | 22 | 98 | 92 |
| B | MoS₂ | 24 | 22 | 96 | 90 |
| C | MnS (with elemental | 20 | 22 | 98 | 92 |
| | sulfur in batch) | | | | |
| D | MnS (without | 19 | 22 | 93 | 84 |
| | elemental sulfur in | | | | |
| | batch) | | | | |
| E | Cr₂O₃ | 24 | 22 | 98 | 88 |
| F | CuO and Cu₂S | 19 | 22 | 97 | 90 |
| G | Fe₂O₃ | 20 | 22 | 97 | 87 |
| H | Iron Acetylacetonate | 19 | 22 | 100 | 87 |
| | (FeAT) | | | | |
| I | FeAT and KI | 20 | 22 | 100 | 90 |

TABLE II

| | Test | | | |
|---|---|---|---|---|
| Example | Time | Hg(T), Inlet | Hg(0) Removal | Hg(T) Removal |
| No. | (Hours) | Conc. (μg · m⁻³) | Efficiency (%) | Efficiency (%) |
| 7 | 72 | 24 | 99 | 100 |
| 8 | 72 | 22 | 99 | 100 |

TABLE III
Mercury removal efficiency (%)
bb

| | Time (Hr) | | | | | | | | | | | | | | | | | | | |
|---|---|---|---|---|---|---|---|---|---|---|---|---|---|---|---|---|---|---|---|---|
| | aa | | | | | | | | | | | | | | | | | | | |
| cc | 1 | 2 | 3 | 5 | 10 | 15 | 20 | 25 | 30 | 35 | 40 | 45 | 50 | 60 | 70 | 80 | 100 | 150 | 200 | 250 |
| 101 | 94 | 94 | 92 | 91 | 91 | 90 | 88 | 87 | 87 | 87 | 87 | 87 | 87 | 88 | 88 | 89 | 88 | 85 | 85 | 86 |
| 201 | 79 | 81 | 85 | 83 | 83 | 84 | 84 | 84 | 84 | 83 | 82 | 80 | 77 | 70 | — | — | — | — | — | — |

aa: time (hour);
bb: mercury removal efficiency (%);
cc: Curve No. as shown in FIG. 1.

1. A process for removing at least one of As, Cd, Hg and Se from a fluid stream, comprising:
(I) providing a plurality of Group A particles of a Group A sorbent material, said Group A sorbent material comprising:
an activated carbon matrix defining a plurality of pores;
sulfur; and
an additive adapted for promoting the removal of at least one of As, Cd, Hg and Se from a fluid stream,
wherein:
the additive is distributed throughout the activated carbon matrix; and
(II) contacting the fluid stream with a plurality of Group A particles of the Group A sorbent material.

2-6. (canceled)

7. A process according to claim 1, wherein:
in step (II), at least part of the plurality of Group A particles are introduced into the fluid stream at a Group A particle introduction location in the form of sorbent powder;
the Group A particles of the sorbent powder are allowed to travel with the fluid stream to a downstream Group A particle collecting location; and
the process further comprises a step (III) as follows:
(III) collecting at least part of the Group A particles of the sorbent powder at the Group A particle collecting location.

8. (canceled)

9. A process according to claim 7, wherein step (III) comprises:
collecting a majority of the Group A particles of the sorbent powder by using a fabric powder collector, an electrostatic precipitator, or a combination thereof.

10. A process according to claim 7, wherein the Group A particles of the sorbent powder have an average Group A particle size ranging from 1 to 200 μm.

11. A process according to claim 1, wherein:
in step (II), at least part of the plurality of Group A particles are contained in a sorbent bed.

12-21. (canceled)

22. A process according to claim 1, further comprising:
(I′) providing a plurality of Group B particles of a Group B sorbent material having a composition differing from that of the Group A material; and
(II′) contacting the fluid stream with a plurality of Group B particles of the Group B sorbent material.

23. A process according to claim 22, wherein the Group B sorbent material comprises an activated carbon matrix defining a plurality of pores and is essentially free of sulfur.

24. A process according to claim 22, wherein the Group B sorbent material comprises an activated carbon matrix defining a plurality of pores and is essentially free of the additive contained in the Group A sorbent material.

25. A process according to claim 22, wherein the Group B sorbent material consists essentially of activated carbon.

26. A process according to claim 22, wherein:
in step (II), at least part of the plurality of Group A particles are contained in a sorbent bed; and
in step (II′), at least part of the plurality of Group B particles are introduced into the fluid stream at a Group B particle introduction location in the form of sorbent powder;
the Group B particles of the sorbent powder are allowed to travel with the fluid stream to a downstream Group B particle collecting location; and
the process further comprises a step (III′) as follows:
(III′) collecting at least part of the Group B particles of the sorbent powder at the Group B particle collecting location.

27-30. (canceled)

31. A process according to claim 1, wherein sulfur is distributed throughout the activated carbon matrix of the Group A sorbent material.

32. A process according to claim 1, wherein the additive is essentially homogeneously distributed in the activated carbon matrix of the Group A sorbent material.

33. A process according to claim 1, wherein sulfur is essentially homogeneously distributed in the activated carbon matrix of the Group A sorbent material.

34-35. (canceled)

36. A process according to claim 1, wherein in the Group A sorbent material, the additive is selected from: (i) halides, oxides and hydroxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; and (iv) combinations and mixtures of two or more of (i), (ii) and (iii).

37. A process according to claim 1, wherein in the Group A sorbent material, the additive is selected from: (i) oxides, sulfides and salts of manganese; (ii) oxides, sulfides and salts of iron; (iii) combinations of (i) and KI; (iv) combinations of (ii) and KI; and (v) mixtures and combinations of any two or more of (i), (ii), (iii) and (iv).

38-48. (canceled)

49. A process according to claim 1, wherein the fluid stream is a gas stream comprising mercury and at least 10% by mole of the mercury in the fluid stream is in elemental state.

50. A process according to claim 1, wherein the fluid stream is a gas stream comprising mercury and at least 50% by mole of the mercury in the gas stream is in elemental state.

51-53. (canceled)

54. A process for making particles of a sorbent material comprising an activated carbon matrix defining a plurality of pores; sulfur; and an additive adapted for promoting the removal of at least one of As, Cd, Hg and Se from a fluid stream, wherein the additive is distributed throughout the activated carbon matrix; comprising:
(a) providing a plurality of batch-mixture particles comprising a carbon-source material, a sulfur-source material, an additive-source material and an optional filler material, wherein the additive-source material is substantially homogeneously distributed in the particles;
(b) carbonizing the batch mixture particles by subjecting the batch mixture particle to an elevated carbonizing temperature in an O₂-depleted atmosphere to obtain a carbonized batch mixture body; and
(c) activating the carbonized batch mixture particles at an elevated activating temperature in a CO₂ and/or H₂O-containing atmosphere.

55. A process according to claim 54, wherein step (a) comprises:
(a1) mixing a carbon-source material, a sulfur-source material, an additive-source material and an optional filler material to obtain an essentially uniform mixture;
(a2) forming wet particles from the mixture; and
(a3) drying the wet particles to obtain dry batch-mixture particles.
